(19) United States
(12) Patent Application Publication
(10) Pub. No.: US 2017/0124726 A1
(43) Pub. Date: May 4, 2017

(54) SYSTEM AND METHOD FOR DETERMINING WALL THICKNESS

(71) Applicant: CANON KABUSHIKI KAISHA, Tokyo (JP)

(72) Inventors: HERVE SOULARD, Beacon Hill (AU); David Karlov, Emu Plains (AU)

(21) Appl. No.: 14/930,371

(22) Filed: Nov. 2, 2015

(51) Int. Cl. G06T 7/60; B33Y 50/02; B33Y 30/00; G06T 17/20; B29C 67/00

(52) U.S. Cl. CPC G06T 7/602; G06T 17/20; B29C 67/0088; B33Y 30/00; B33Y 50/02; G06T 2219/012

(57) ABSTRACT

Systems and methods for determining a wall thickness of an object defined by a surface mesh model receiving an initial polygon and a neighbouring polygon of the surface mesh model sharing at least one vertex with the initial polygon. Each received polygon is associated with a search volume extending inside the object substantially perpendicular to a surface of the corresponding polygon. The method determines, based on normals to the surfaces of the initial polygon and the neighbouring polygon, a region inside the object, the determined region being between the search volumes of the initial polygon and the neighbouring polygon. The method expands the search volume associated with the initial polygon towards the determined region to form an expanded search volume, and then determines the wall thickness of the initial polygon using a distance from the initial polygon to a further polygon within the expanded search volume.

### TECHNICAL FIELD

The present invention relates generally to mesh processing for 3D printing. In particular, the present invention relates to a method and system for determining a wall thickness of an object in a single surface mesh, for detecting potential 3D printing problems.

### BACKGROUND

Many failed 3D printing attempts are caused by wall thickness problems. Spikes, membranes, or connecting rods in a 3D surface mesh model which are too thin will not be reproduced faithfully when printed. Such leads to 3D printing failures including the disappearance of important parts, the emergence of holes, or disconnections. Such may also lead to printed products having wall portions of a thickness which is insufficiently robust for normal use. Once the parts or regions of a 3D model containing wall thickness problems have been identified, a user can apply fixing operations to correct the identified problems. The process of identifying wall thickness problems is called “wall thickness analysis”. Manual processes for wall thickness analysis are known, but they are tedious, time-consuming, and require expert skill An automated wall thickness analysis process is thus highly desirable.

However, some automated methods do not guarantee that all thin features will be detected on all surfaces of a 3D mesh model. Further, some automated methods may not be suitable for all types of 3D mesh models. Other methods of detecting wall thickness may be difficult to automate.

One approach to wall thickness analysis involves shooting rays from points on the surface, into the interior of the model, and finding the distance of the rays before they strike some opposite surface. Such ray shooting methods are sampled methods, and as such cannot guarantee that all thin features will be detected on all surfaces. This means that critical printability problems can be missed.

Another approach finds the wall thickness at each polygon in a polygon mesh by searching for other polygons by means of an angle threshold parameter. The distance from the search polygon to the nearest polygon satisfying the angle parameter is used to calculate a thickness value at the search polygon. With a wide angle threshold value, such as 90 degrees, this approach identifies wall thickness problems which ray casting misses, but also finds many false positives—many regions are classified as too thin which are actually unproblematic. With a narrower angle threshold value, such as 30 degrees, the detection of thin features comes to depend on the angle of the opposite wall, leading to unintuitive results in the case of a noisy surface, with many polygons all at slightly different angles. Noisy surfaces are typical of models deriving from 3D scanning processes, which have recently gained popularity as a source of data for 3D printing. An example of unintuitive output from this prior art method is shown in an example output 1300 of FIG. 13, in which clusters of faces identified as thin are coloured black with white boundaries. Moreover, the angle threshold value is left for a user to manually select based on his or her expertise, while clearly a single angle threshold value may not be suitable for all 3D models.

Further known approaches propagate a search for an “opposite” polygon inside the model based on 3D grid cells lying within a cone stemming from the search polygon, or within a cylindrical scan region positioned some distance away from the search polygon, to find the wall thickness at a search polygon. In each case, the orientation of the search volume is guided by the normal direction of the search polygon. This means that critical thin wall issues can be missed, depending on the geometry of the model. For example, a shape 600 of FIG. 6A whose cross-section is a thin “waist” region surrounded by polygons at sharp angles has a critical thin region 650 which is not detected at face 601 or any other face of the model by using either a conical scan region 620 of FIG. 6B, or a cylindrical scan region 630 of FIG. 6C. Furthermore, in the case of the cylindrical scan volume, the size and shape of the scan volume depend on user parameters, making the method difficult to automate.

Thus, a need exists for a robust method of determining wall thickness of a surface mesh model.

### SUMMARY

It is an object of the present disclosure to substantially overcome, or at least ameliorate, at least one disadvantage of present arrangements.

The arrangements presently disclosed afford a technical improvement in the reliability of 3D printing, which allows savings on materials and other resources spent on printing 3D surface mesh models which inherently have 3D printability problems. The improvement is accomplished by estimating wall thickness so that potential wall thickness problems can be timely detected before printing process has started.

A first aspect of the present disclosure provides a method of determining a wall thickness of an object defined by a surface mesh model, the method comprising: receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon; determining, based on normals to the surfaces of the initial polygon and the neighbouring polygon, a region inside the object, the determined region being between the search volumes of the initial polygon and the neighbouring polygon; expanding the search volume associated with the initial polygon towards the determined region to form an expanded search volume, so that the determined region is covered by a combination of the search volumes of the initial polygon and the neighbouring polygon; and determining the wall thickness of the initial polygon using a distance from the initial polygon to a further polygon within the expanded search volume.

According to another aspect of the present disclosure, the combination of the search volumes comprises a single expanded search volume.

According to another aspect of the present disclosure, the combination of the search volumes comprises a pair of expanded search volumes.

According to another aspect of the present disclosure, expanding the search volume associated with the initial polygon comprises re-orienting a boundary of the search volume, the boundary being substantially parallel with the initial polygon surface normal and passing through the at least one shared vertex.

According to another aspect of the present disclosure, re-orienting the boundary of the search volume comprises orienting the boundary at an angle substantially midway between the initial polygon surface normal and the neighbouring polygon surface normal.

According to another aspect of the present disclosure, the search volume associated with the initial polygon is substantially bounded by the initial polygon and three boundary planes, each boundary plane passing through an edge of the initial polygon.

According to another aspect of the present disclosure, the neighbouring polygon shares an edge with the initial polygon.

According to another aspect of the present disclosure, expanding the search volume comprises rotating the boundary plane passing through the shared edge about the shared edge.

According to another aspect of the present disclosure, the polygon is triangular.

According to another aspect of the present disclosure, the polygon is quadrilateral.

According to another aspect of the present disclosure, the expanded search volume is further formed by addition of one or more further bounding planes, the further bounding planes being substantially perpendicular to the initial polygon, and passing through one of the at least one vertices, substantially perpendicular to the vertex normal.

According to another aspect of the present disclosure, the method further comprises expanding the search volume of the neighbouring polygon to cover the determined region.

According to another aspect of the present disclosure, the expanded search volumes of the initial polygon and the neighbouring polygon abut with no gaps therebetween.

According to another aspect of the present disclosure, the expanded search volumes of the initial polygon and the neighbouring polygon overlap.

A further aspect of the present disclosure provides a method for determining a wall thickness of an object defined by a surface mesh model, the method comprising: selecting an initial polygon in the surface mesh model, the initial polygon being associated with a search volume extending inside the object substantially perpendicular to the surface of the initial polygon; determining whether the initial polygon forms a concave set with an adjacent polygon from the surface mesh model, wherein the adjacent polygon shares at least one vertex with the selected polygon; if the initial polygon and the adjacent polygon form a concave set, expanding the search volume associated with the selected polygon towards a region between the normal to the surface of the initial polygon and the normal to the surface of the adjacent polygon to form an expanded volume, so that said region is covered by a combination of search volumes of the initial polygon and the adjacent polygon; and determining a distance between the initial polygon and at least one further polygon within the expanded search volume to determine a wall thickness of the object.

A yet further aspect of the present disclosure provides a method for determining a wall thickness of an object defined by a surface mesh model, the method comprising: receiving a pair of concave neighbouring polygons sharing at least one vertex in the surface mesh model; for each polygon in the pair, determining a search volume extending inside the object from the surface of the corresponding polygon and having at least one boundary passing through the shared vertex in a direction defined by normal vectors to the surfaces of the first and second polygons in the pair; and determining the wall thickness of the object using a distance between a polygon in the pair and a further polygon within the respective search volume.

A yet further aspect of the present disclosure provides a method for determining printability of a surface mesh model, the method comprising: selecting a polygon from the surface mesh model forming a concave angle with respect to at least one neighbouring polygon; dynamically varying a search volume within determinable constraints associated with the selected polygon based on the orientation of the selected polygon relative to the at least one neighbouring polygon to determine the wall thickness of the selected polygon; and determining printability of the surface mesh model using the determined wall thickness.

According to another aspect of the present disclosure, the method further comprises determining the search volume associated with the selected polygon, the determined search volume being an evolved prism.

According to another aspect of the present disclosure, vertices bounding a cross-section of the determined search volume at a height above and perpendicular to the polygon is linearly dependent on the height.

According to another aspect of the present disclosure, the search volume is varied by redefining a bounding edge of the determined search volume associated with a selected vertex of the selected polygon such that the bounding edge is aligned with a normal of the selected polygon.

A further aspect of the present disclosure provides an apparatus for determining a wall thickness of an object defined by a surface mesh model, the apparatus comprising: a memory; and a processor coupled to the memory for executing a computer program, the computer program comprising instructions for: receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon; determining, based on normals to the surfaces of the initial polygon and the neighbouring polygon, a region inside the object, the determined region being between the search volumes of the initial polygon and the neighbouring polygon; expanding the search volume associated with the initial polygon towards the determined region to form an expanded search volume, so that the determined region is covered by a combination of the search volumes of the initial polygon and the neighbouring polygon; and determining the wall thickness of the initial polygon using a distance from the initial polygon to a further polygon within the expanded search volume.

A further aspect of the present disclosure provides a non-transitory computer readable storage medium having a program recorded thereon, the program being executable by a processor for determining a wall thickness of an object defined by a surface mesh model, the program comprising: code for receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon; code for determining, based on normals to the surfaces of the initial polygon and the neighbouring polygon, a region inside the object, the determined region being between the search volumes of the initial polygon and the neighbouring polygon; code for expanding the search volume associated with the initial polygon towards the determined region to form an expanded search volume, so that the determined region is covered by a combination of the search volumes of the initial polygon and the neighbouring polygon; and code for determining the wall thickness of the initial polygon using a distance from the initial polygon to a further polygon within the expanded search volume.

A further aspect of the present disclosure provides a system, comprising: a 3D printing device; a computing device; and a communications network coupling the computing device to the 3D printing device; wherein the system is adapted to receive, at the computing device, an initial polygon of a surface mesh model and a neighbouring polygon of the surface mesh model, the surface mesh model representing a product for printing by the 3D printing device, the neighbouring polygon sharing, in the surface mesh model, at least one vertex with the initial polygon, each received polygon being associated with a search volume extending inside the object substantially perpendicular to a surface of the corresponding polygon; determining, by the computing device, based on normals to the surfaces of the initial polygon and the neighbouring polygon, a region inside the object, the determined region being between the search volumes of the initial polygon and the neighbouring polygon; expand, by the computing device, the search volume associated with the initial polygon towards the determined region to form an expanded search volume, so that the determined region is covered by a combination of the search volumes of the initial polygon and the neighbouring polygon; and determine, by the computing device, the wall thickness of the initial polygon using a distance from the initial polygon to a further polygon within the expanded search volume; and print, by the 3D printing device, the product represented by the surface mesh model depending on the determined wall thickness.

### BRIEF DESCRIPTION OF THE DRAWINGS

One or more embodiments of the invention will now be described with reference to the following drawings, in which:

FIGS. 1A and 1B form a schematic block diagram of a general purpose computer system upon which arrangements described can be practiced.

FIG. 1C is a schematic block diagram of a mesh processing architecture;

FIG. 2 is a schematic flow diagram illustrating a method of wall thickness analysis;

FIG. 3 is a schematic flow diagram illustrating a method of constructing a search volume as used in the method of FIG. 2;

FIG. 4 is a schematic flow diagram illustrating a method of finding the nearest face within a search volume as used in the method of FIG. 2;

FIG. 5 is a schematic flow diagram illustrating a method of determining whether a face intersects a search volume as used in the method of FIG. 4;

FIGS. 6A-6C illustrate some prior art wall thickness analysis methods applied to an example polygon mesh;

FIGS. 7A and 7B show operation of a method of wall thickness analysis applied to an example polygon mesh;

FIG. 8 illustrates methods of calculating a distance between two faces as used in the method of FIG. 2.

FIGS. 9A(1)-9A(3) show various views of a search volume constructed using the method of FIG. 3;

FIGS. 9B(1)-9B(3) show various views of a search volume constructed using the method of FIG. 10;

FIGS. 9C(1)-9C(3) show various views of a search volume constructed using the method of FIG. 10;

FIGS. 9D(1)-9D(3) show various views of a search volume constructed using the method of FIG. 10;

FIG. 10 is a schematic flow diagram illustrating a method of constructing a search volume;

FIG. 11 is a schematic flow diagram illustrating a further method of constructing a search volume; and

FIGS. 12A-12B illustrate various views of a search volume constructed using the method of FIG. 11;

FIG. 13 shows the output of a prior art wall thickness analysis method;

FIGS. 14A and 14B show an example of a single surface mesh and several wall thicknesses of the mesh;

FIGS. 15A and 15B show operation of a method of wall thickness analysis applied to an example polygon mesh;

FIGS. 16A and 16B show operation of a method of wall thickness analysis applied to an example polygon mesh; and

FIGS. 17A and 17B show operation of a method of wall thickness analysis applied to an example polygon mesh.

### DETAILED DESCRIPTION INCLUDING BEST MODE

Where reference is made in any one or more of the accompanying drawings to steps and/or features, which have the same reference numerals, those steps and/or features have for the purposes of this description the same function(s) or operation(s), unless the contrary intention appears.

The present disclosure relates to a method of determining a wall thickness of each polygon (also referred to as face) in a single surface mesh for a 3D printing.

A single surface mesh for 3D printing represents a design of a final product to be produced by a 3D printing device. A single surface mesh is typically divided into a plurality of polygons (also referred to as faces). The polygons or faces forming the mesh may be substantially planar, or non-planar. The arrangements herein may relate to planar polygons or faces but may also be applied to non-planar polygons, for example quadrilateral polygons, as discussed hereafter. The single surface mesh (also referred to as a mesh) may be formed by a CAD tool, such as AutoCAD™ (produced by AutoDesk) or SolidWorks™ (produced by Dassault Systemes). In some arrangements, the single surface mesh may be generated by a software application using a point cloud obtained from a 3D scanner. The arrangements described do not relate to generation of the mesh, rather analysis of wall thickness of the mesh,

FIG. 14A shows a sample single surface mesh 1400 of a thin-waisted rod for 3D printing, having several walls of different thicknesses. The surface mesh 1400 may typically be described in terms of a number of connected polygons or faces, such as the polygon 1401a which forms part of planar region 1401 on the top of the model. FIG. 14B shows a cross section 1420 of the mesh and several sample wall thicknesses of the mesh, 1451, 1452, and 1453, at the cross section 1420. The example of FIG. 14A relates to a mesh with relatively planar surfaces described as planar polygons, such as the polygon 1401a. Other mesh arrangements may relate to non-planar surfaces described in terms of non-planar polygons, such as quadrilateral polygons.

Determination of wall thickness determines a printability of the object depicted by the single surface mesh using a 3D printing device. Printability of the object can firstly be considered in relation to capabilities of the relevant printing device, and properties of a material from which the object is to be formed. Printability can also be considered in terms of whether the printed object would be sufficiently robust for general use. Determining printability assists in predicting potential problems and costs in relation to time, materials or other resources associated with 3D printing.

In the arrangements described herein, a search volume is constructed substantially perpendicular to a first face of a mesh relating to a 3D product, for which a wall thickness is being determined. For each neighbour of the first face, if the neighbour and the first face together form a concave angle, the search volume is expanded in the direction of the neighbour. When this process is applied to the search volume of the initial face, and also to the search volume of the neighbour, the two search volumes cover all of the space between them leaving no gaps, ensuring that all thin walls in a surface mesh which could impact the printability of the shape are detected in the determined wall thickness values.

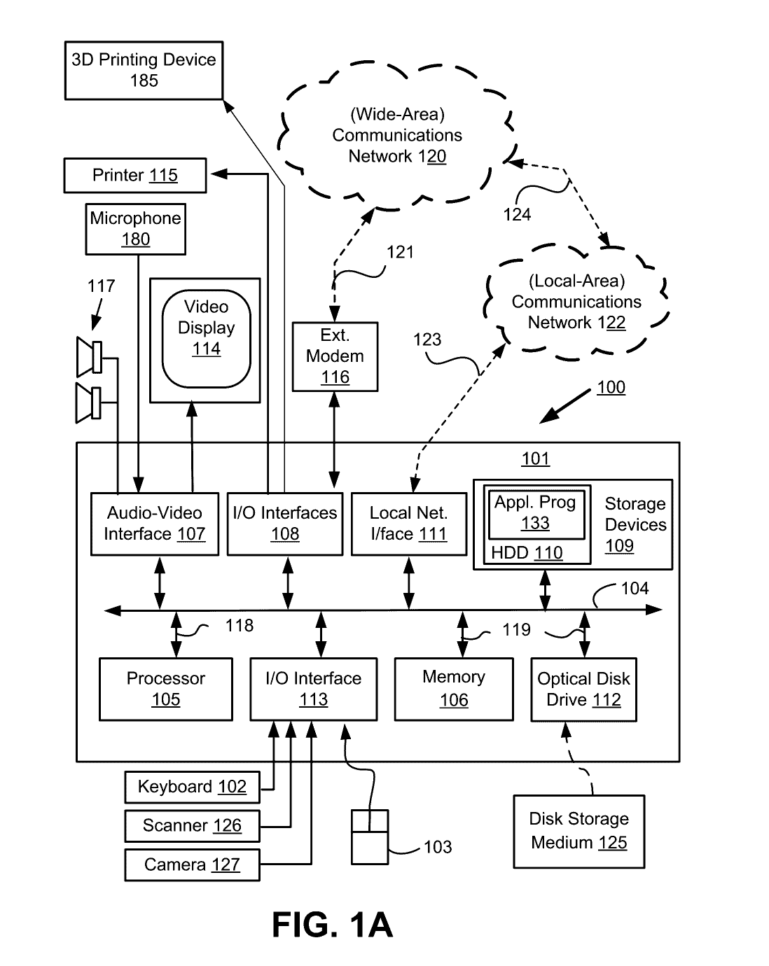

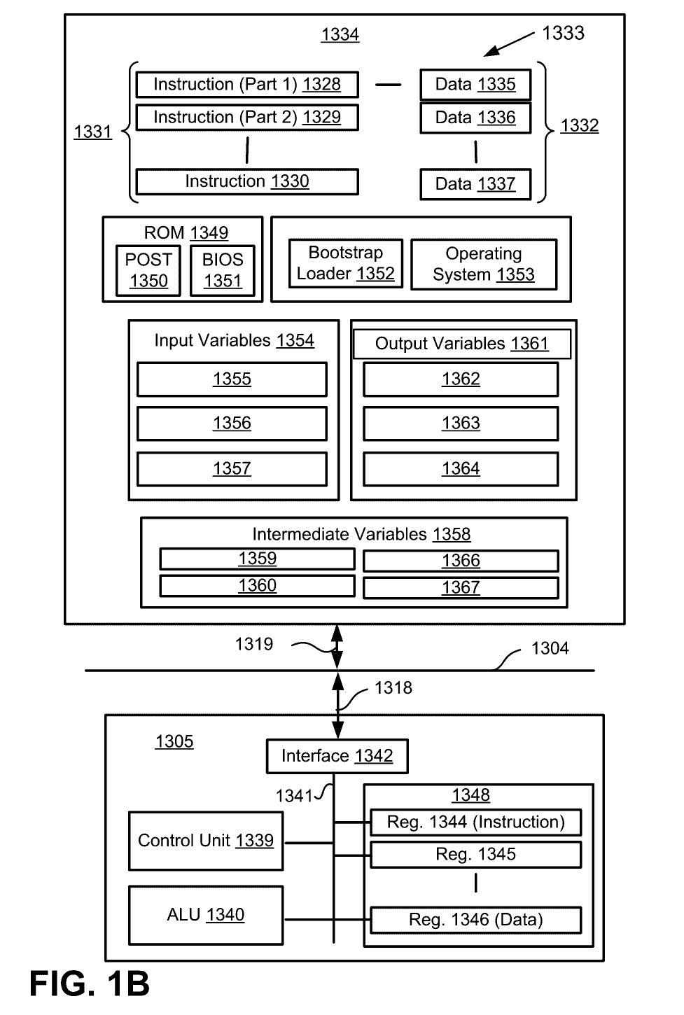

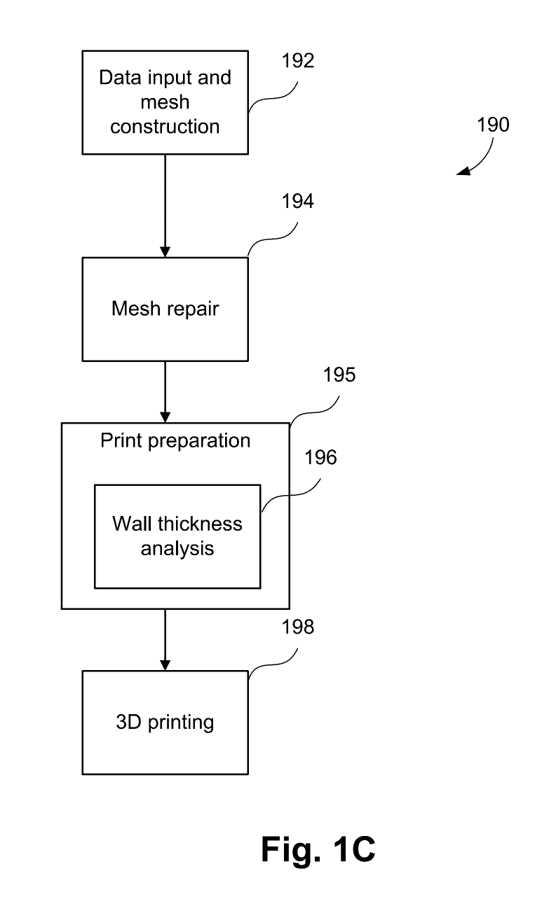

FIG. 1A shows a system upon which the various arrangements described can be practiced.

FIGS. 1A and 1B depict a general-purpose computer system 100, upon which the various arrangements described can be practiced.

As seen in FIG. 1A, the computer system 100 includes: a computer module 101; input devices such as a keyboard 102, a mouse pointer device 103, a scanner 126, a camera 127, and a microphone 180; and output devices including a printer 115, a 3D printing device 185 (also referred to as a 3D printer), a display device 114 and loudspeakers 117. An external Modulator-Demodulator (Modem) transceiver device 116 may be used by the computer module 101 for communicating to and from a communications network 120 via a connection 121. The communications network 120 may be a wide-area network (WAN), such as the Internet, a cellular telecommunications network, or a private WAN. Where the connection 121 is a telephone line, the modem 116 may be a traditional “dial-up” modem. Alternatively, where the connection 121 is a high capacity (e.g., cable) connection, the modem 116 may be a broadband modem. A wireless modem may also be used for wireless connection to the communications network 120.

The computer module 101 typically includes at least one processor unit 105, and a memory unit 106. For example, the memory unit 106 may have semiconductor random access memory (RAM) and semiconductor read only memory (ROM). The computer module 101 also includes an number of input/output (I/O) interfaces including: an audio-video interface 107 that couples to the video display 114, loudspeakers 117 and microphone 180; an I/O interface 113 that couples to the keyboard 102, mouse 103, scanner 126, camera 127 and optionally a joystick or other human interface device (not illustrated); and an interface 108 for the external modem 116 and printer 115. In some implementations, the modem 116 may be incorporated within the computer module 101, for example within the interface 108. The computer module 101 also has a local network interface 111, which permits coupling of the computer system 100 via a connection 123 to a local-area communications network 122, known as a Local Area Network (LAN). As illustrated in FIG. 1A, the local communications network 122 may also couple to the wide network 120 via a connection 124, which would typically include a so-called “firewall” device or device of similar functionality. The local network interface 111 may comprise an Ethernet circuit card, a Bluetooth® wireless arrangement or an IEEE 802.11 wireless arrangement; however, numerous other types of interfaces may be practiced for the interface 111.

The I/O interfaces 108 and 113 may afford either or both of serial and parallel connectivity, the former typically being implemented according to the Universal Serial Bus (USB) standards and having corresponding USB connectors (not illustrated). Storage devices 109 are provided and typically include a hard disk drive (HDD) 110. Other storage devices such as a floppy disk drive and a magnetic tape drive (not illustrated) may also be used. An optical disk drive 112 is typically provided to act as a non-volatile source of data. Portable memory devices, such optical disks (e.g., CD-ROM, DVD, Blu-ray Disc™), USB-RAM, portable, external hard drives, and floppy disks, for example, may be used as appropriate sources of data to the system 100.

The components 105 to 113 of the computer module 101 typically communicate via an interconnected bus 104 and in a manner that results in a conventional mode of operation of the computer system 100 known to those in the relevant art. For example, the processor 105 is coupled to the system bus 104 using a connection 118 Likewise, the memory 106 and optical disk drive 112 are coupled to the system bus 104 by connections 119. Examples of computers on which the described arrangements can be practised include IBM-PC's and compatibles, Sun Sparcstations, Apple Mac™ or like computer systems.

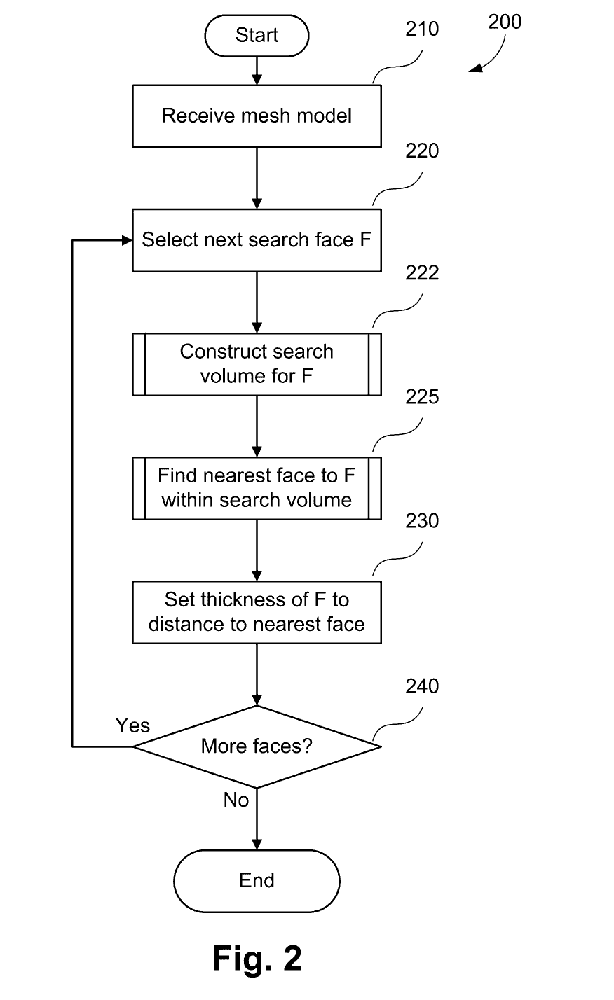

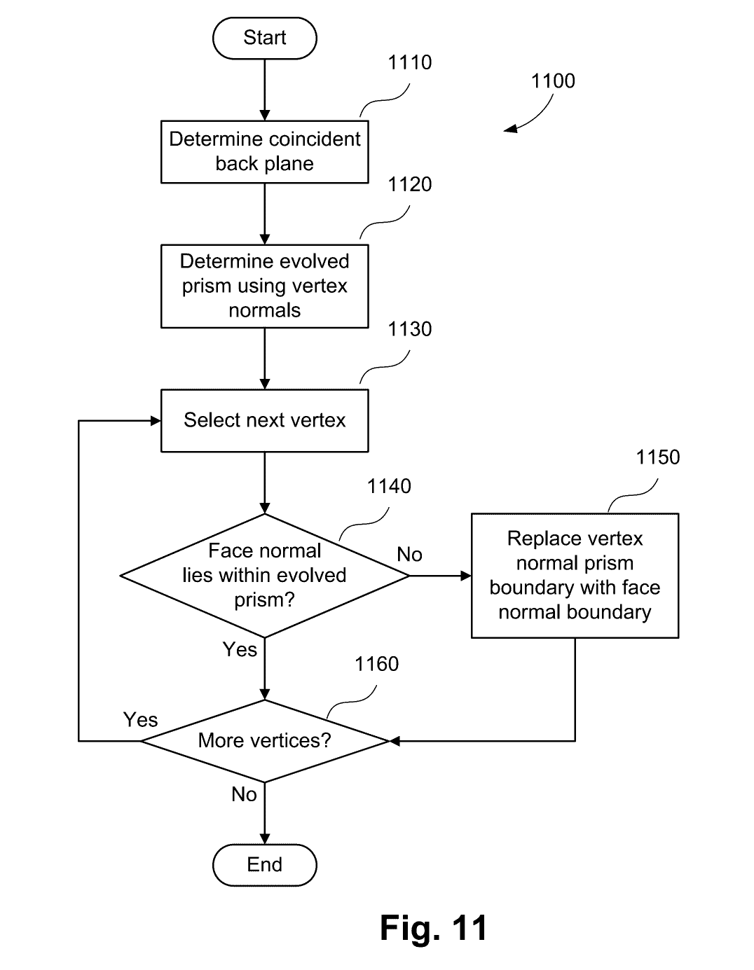

The methods of FIGS. 2-5, 10 and 11 may be implemented using the computer system 100 wherein the processes of FIGS. 2-5, 10 and 11, to be described, may be implemented as one or more software application programs 133 executable within the computer system 100. In particular, the steps of the method of FIG. 2 are effected by instructions 131 (see FIG. 1B) in the software 133 that are carried out within the computer system 100. The software instructions 131 may be formed as one or more code modules, each for performing one or more particular tasks. The software may also be divided into two separate parts, in which a first part and the corresponding code modules performs the methods described herein and a second part and the corresponding code modules manage a user interface between the first part and the user.

The software may be stored in a computer readable medium, including the storage devices described below, for example. The software is loaded into the computer system 100 from the computer readable medium, and then executed by the computer system 100. A computer readable medium having such software or computer program recorded on the computer readable medium is a computer program product. The use of the computer program product in the computer system 100 preferably effects an advantageous apparatus for analysing wall thickness of single surface mesh.

The software 133 is typically stored in the HDD 110 or the memory 106. The software is loaded into the computer system 100 from a computer readable medium, and executed by the computer system 100. Thus, for example, the software 133 may be stored on an optically readable disk storage medium (e.g., CD-ROM) 125 that is read by the optical disk drive 112. A computer readable medium having such software or computer program recorded on it is a computer program product. The use of the computer program product in the computer system 100 preferably effects an apparatus for analysing wall thickness of single surface mesh.

In some instances, the application programs 133 may be supplied to the user encoded on one or more CD-ROMs 125 and read via the corresponding drive 112, or alternatively may be read by the user from the networks 120 or 122. Still further, the software can also be loaded into the computer system 100 from other computer readable media. Computer readable storage media refers to any non-transitory tangible storage medium that provides recorded instructions and/or data to the computer system 100 for execution and/or processing. Examples of such storage media include floppy disks, magnetic tape, CD-ROM, DVD, Blu-ray™ Disc, a hard disk drive, a ROM or integrated circuit, USB memory, a magneto-optical disk, or a computer readable card such as a PCMCIA card and the like, whether or not such devices are internal or external of the computer module 101. Examples of transitory or non-tangible computer readable transmission media that may also participate in the provision of software, application programs, instructions and/or data to the computer module 101 include radio or infra-red transmission channels as well as a network connection to another computer or networked device, and the Internet or Intranets including e-mail transmissions and information recorded on Websites and the like.

The second part of the application programs 133 and the corresponding code modules mentioned above may be executed to implement one or more graphical user interfaces (GUIs) to be rendered or otherwise represented upon the display 114. Through manipulation of typically the keyboard 102 and the mouse 103, a user of the computer system 100 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 117 and user voice commands input via the microphone 180.

FIG. 1B is a detailed schematic block diagram of the processor 105 and a “memory” 134. The memory 134 represents a logical aggregation of all the memory modules (including the HDD 109 and semiconductor memory 106) that can be accessed by the computer module 101 in FIG. 1A.

When the computer module 101 is initially powered up, a power-on self-test (POST) program 150 executes. The POST program 150 is typically stored in a ROM 149 of the semiconductor memory 106 of FIG. 1A. A hardware device such as the ROM 149 storing software is sometimes referred to as firmware. The POST program 150 examines hardware within the computer module 101 to ensure proper functioning and typically checks the processor 105, the memory 134 (109, 106), and a basic input-output systems software (BIOS) module 151, also typically stored in the ROM 149, for correct operation. Once the POST program 150 has run successfully, the BIOS 151 activates the hard disk drive 110 of FIG. 1A. Activation of the hard disk drive 110 causes a bootstrap loader program 152 that is resident on the hard disk drive 110 to execute via the processor 105. This loads an operating system 153 into the RAM memory 106, upon which the operating system 153 commences operation. The operating system 153 is a system level application, executable by the processor 105, to fulfil various high level functions, including processor management, memory management, device management, storage management, software application interface, and generic user interface.

The operating system 153 manages the memory 134 (109, 106) to ensure that each process or application running on the computer module 101 has sufficient memory in which to execute without colliding with memory allocated to another process. Furthermore, the different types of memory available in the system 100 of FIG. 1A must be used properly so that each process can run effectively. Accordingly, the aggregated memory 134 is not intended to illustrate how particular segments of memory are allocated (unless otherwise stated), but rather to provide a general view of the memory accessible by the computer system 100 and how such is used.

As shown in FIG. 1B, the processor 105 includes a number of functional modules including a control unit 139, an arithmetic logic unit (ALU) 140, and a local or internal memory 148, sometimes called a cache memory. The cache memory 148 typically includes a number of storage registers 144-146 in a register section. One or more internal busses 141 functionally interconnect these functional modules. The processor 105 typically also has one or more interfaces 142 for communicating with external devices via the system bus 104, using a connection 118. The memory 134 is coupled to the bus 104 using a connection 119.

The application program 133 includes a sequence of instructions 131 that may include conditional branch and loop instructions. The program 133 may also include data 132 which is used in execution of the program 133. The instructions 131 and the data 132 are stored in memory locations 128, 129, 130 and 135, 136, 137, respectively. Depending upon the relative size of the instructions 131 and the memory locations 128-130, a particular instruction may be stored in a single memory location as depicted by the instruction shown in the memory location 130. Alternately, an instruction may be segmented into a number of parts each of which is stored in a separate memory location, as depicted by the instruction segments shown in the memory locations 128 and 129.

In general, the processor 105 is given a set of instructions which are executed therein. The processor 105 waits for a subsequent input, to which the processor 105 reacts to by executing another set of instructions. Each input may be provided from one or more of a number of sources, including data generated by one or more of the input devices 102, 103, data received from an external source across one of the networks 120, 102, data retrieved from one of the storage devices 106, 109 or data retrieved from a storage medium 125 inserted into the corresponding reader 112, all depicted in FIG. 1A. The execution of a set of the instructions may in some cases result in output of data. Execution may also involve storing data or variables to the memory 134.

The disclosed arrangements use input variables 154, which are stored in the memory 134 in corresponding memory locations 155, 156, 157. The disclosed arrangements produce output variables 161, which are stored in the memory 134 in corresponding memory locations 162, 163, 164. Intermediate variables 158 may be stored in memory locations 159, 160, 166 and 167.

Referring to the processor 105 of FIG. 1B, the registers 144, 145, 146, the arithmetic logic unit (ALU) 140, and the control unit 139 work together to perform sequences of micro-operations needed to perform “fetch, decode, and execute” cycles for every instruction in the instruction set making up the program 133. Each fetch, decode, and execute cycle comprises:

a fetch operation, which fetches or reads an instruction 131 from a memory location 128, 129, 130;

a decode operation in which the control unit 139 determines which instruction has been fetched; and

an execute operation in which the control unit 139 and/or the ALU 140 execute the instruction.

Thereafter, a further fetch, decode, and execute cycle for the next instruction may be executed. Similarly, a store cycle may be performed by which the control unit 139 stores or writes a value to a memory location 132.

Each step or sub-process in the processes of FIGS. 2-5, 10 and 11 is associated with one or more segments of the program 133 and is performed by the register section 144, 145, 147, the ALU 140, and the control unit 139 in the processor 105 working together to perform the fetch, decode, and execute cycles for every instruction in the instruction set for the noted segments of the program 133.

The 3D printing device 185 (also referred to as a 3D printer) may be any device suitable to create a 3-dimensional object from a mesh model. For example, the 3D printing device 185 may use additive manufacturing processes. The 3D printing device 185 may be connected directly to the computer module 101, for example by the interface 108 as shown. In other arrangements, the 3D printer may be connected to the computer module 101 via a network, including a local area network such as the network 122 or a wide network such as the network 120. In some instances, the 3D printer 185 may be connected to the computer module 101 via a cloud computing server (not shown) accessible via the network 120.

FIG. 1C shows a 3D mesh processing architecture 190 by which the arrangements described can be applied. The mesh processing architecture 190 can be implemented as a submodule of the software application 133 stored on the computer module 101, for example stored in the memory 106 or on the hard disk drive 110. In other arrangements, the mesh processing architecture 190 may be stored on a cloud server accessible via a connection such as the connection 121. In other arrangements, the mesh processing architecture 190 may be stored as an embedded architecture on the 3D printer 185.

The mesh processing architecture 190 comprises a data input and mesh construction module 192, a mesh repair module 194, a print preparation module 195 and a 3D printing module 199. The mesh processing architecture 190 is executable on the processor 105.

The data input and mesh construction module 192 executes to generates surface mesh data for a 3D single surface mesh model, for example by triangulating a CAD design that was created using CAD editing software. The surface mesh data represents a 3D object to be printed by the device 185. In other arrangement, the module 192 executes to perform surface reconstruction on one or more point clouds obtained via a 3D scanner. A single surface mesh model is typically stored as a list of faces (or polygons), and a list of vertices. The single surface mesh model may be stored in the memory 106, for example. Each face of the single surface mesh has a list of references to the vertices corresponding to that face. Each vertex is stored as geometrical X, Y, Z co-ordinate information. The surface mesh is generated by the module 192 and passed to the mesh repair module 194. The module 194 executes to perform general repair operations on the single surface mesh, including correcting topological errors, removing degenerate (zero-area) polygons (faces), filling holes in the mesh topology, removing self-intersections, and enforcing a consistent face orientation.

The module 194 generates a resulting refined single surface mesh (also referred to as a refined mesh). The refined mesh is passed from the module 194 to the print preparation module 195. The module 195 executes to check the 3D printability of the refined surface mesh and processes the refined surface mesh further in preparation for printing on the 3D printer 185 with specified printing material. One of the checking operations executed by the module 195 is a wall thickness analysis, which is performed by a wall thickness analysis module 196. The wall thickness analysis module 196 executes to analyse the thickness of walls in the refined mesh surface, and returns wall thickness information to the print preparation module 195.

The print preparation module 195 presents the wall thickness information via a graphical user interface (GUI) to a user of the computer module 101, for example via the display 114. The GUI may allow the user to fix any wall thickness problems present, resulting in a prepared mesh. The prepared mesh has suitable wall thicknesses for printability, for example, in relation to properties of the 3D printer 185 and corresponding printing material, or a robust resultant product. The thickness information may be presented via the GUI as a thickness value in millimetres. Alternatively, the thickness information can be presented by colour-coding the refined mesh data in accordance with a mapping of predetermined colours to corresponding ranges of thickness values. For example, one colour can be designated to a range of thickness values defining “thin” walls, e.g. having thickness values ranging from 0 to 0.7 mm, while another colour may be used for a range of thickness values defining “thick” walls, for example with thickness values exceeding 5 mm. The GUI may be adapted to display the mesh with some polygons (faces) highlighted depending on their thickness. For example, the GUI may highlight polygons for which wall thickness is below or above a predetermined threshold. The GUI is also responsive to commands from a user to modify the wall thickness.

The 3D printing module 198 executes to drive the 3D printer 185, using the prepared mesh, to create a physical object based on the original design.

In other arrangements of the architecture 190, modules 192 and/or 194 may be excluded. In such arrangements, the architecture 190 may receive a refined surface mesh model generated on a device other than the module 101.

The wall thickness analysis module 196 executes to determine the wall thickness at each polygon (face) of the refined surface mesh according to the method 200 of FIG. 2. The method 200 may be implemented by one or more submodules of the application 133, stored in the memory 106 controlled by execution of the processor 105.

The method 200 starts upon the module 195 receiving a refined surface polygon mesh model at step 210. The method 200 executes to continue from step 210 to step 220. The module 196 executes to select a face (polygon) within the refined mesh model at step 220.

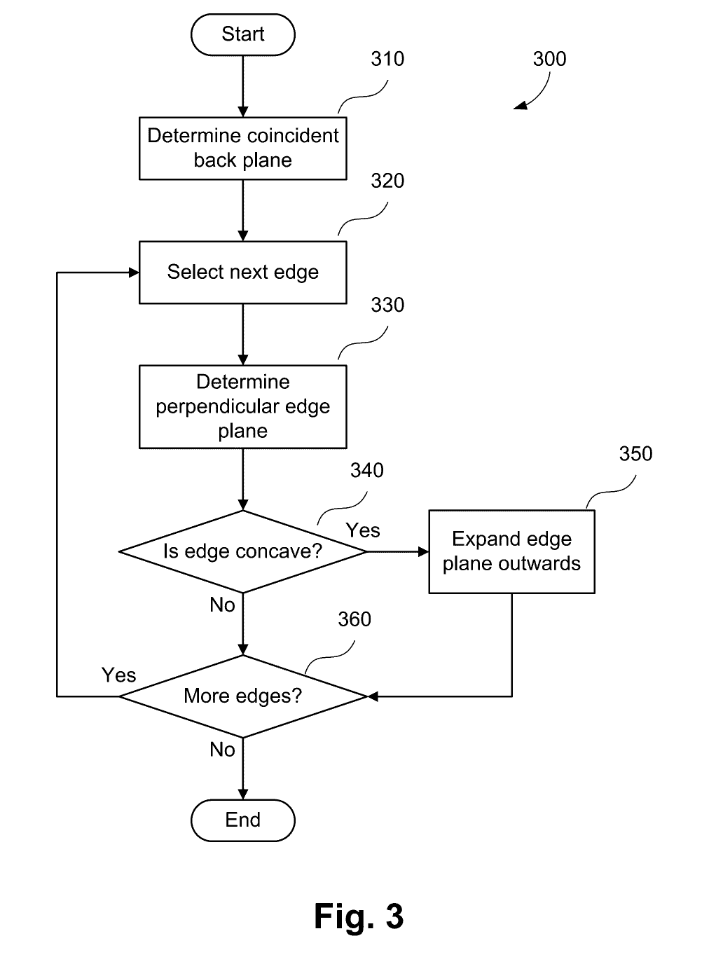

The method 200 executes to continue from step 220 to step 222. Step 222 executes on the processor 105 to construct a search volume associated with the selected face. A method 300 of constructing a search volume, as executed at step 222, is described hereafter in relation to FIG. 3. Execution of the step 222 involves constructing a prism perpendicular to the selected face, and bounded by an edge plane. The edge plane is perpendicular to the selected face. Step 222 involves, for each edge of the face (polygon) and the plane of the face, expanding the search volume by “swinging out” an edge plane if the edge is concave with respect to a neighbour polygon.

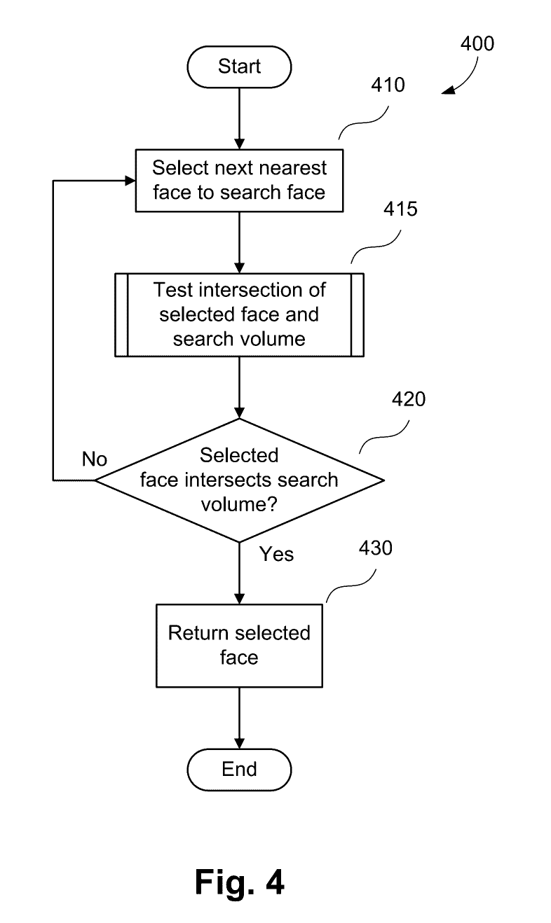

The method 200 executes to progress from step 222 to step 225. Step 225 executes to find the nearest face to the selected face within the expanded search volume. A method 400 of finding the nearest face, as executed at step 225, is described hereafter in relation to FIG. 4.

The method 200 executes to progress from step 225 to step 230. The module 196 executes at step 230 to set the thickness of the selected face to the distance from the selected face to the nearest face in step 230. The method 200 executes to progress from step 230 to step 240. At step 240, the module 196 executes to determine if more faces are present in the single surface mesh model. If more surface are present (“Yes” at step 240), steps 220 through 230 are repeated. The steps 220 thorough 230 are repeated for every face in the mesh until step 240 returns a “No”, that is all faces have been analysed, and the method 200 ends.

The effect of expanding the search volumes in step 222 is to ensure that no gaps are left between search volumes of neighbouring faces in which potentially unprintable wall thicknesses could go undetected. As a result, the wall thickness information determined in step 230 reliably indicates all regions (faces or polygons) of the mesh model which are too thin or too thick to be printed correctly on the target 3D printing device 185. For example, if a polygon in the mesh model is identified as too thin, for example with respect to a threshold thickness, this suggests that the mesh model may be printed with holes or overall is fragile to be used. Alternatively, if a polygon is determined as too thick with respect to the threshold, the 3D printer 185 would need to use more printing material, such as plastic, metal or nylon, than required to print a particular shape. It is desirable to present such problematic regions to the user. The user can then correct the identified problematic regions using the GUI and successfully 3D print the corrected mesh model.

With reference to FIG. 2, the method 200 for performing wall thickness analysis within wall thickness analysis module 196 begins in step 210 by receiving data related to the refined polygon mesh. The refined polygon mesh data is manifold, closed, oriented, and has no degeneracies or self-intersections, as a result of the prior operation of the mesh repair module 194. The refined polygon mesh data is preferably triangular, such that each polygon (face) has three edges. The polygon mesh data is stored in a memory, such as the memory 106. The refined mesh data comprises a list of faces and a list of vertices.

Each vertex in the list of vertices is represented by three floating-point numbers, which respectively specify the vertex's geometric position in the X, Y, and Z dimensions relative to an origin of a coordinate system of the refined mesh. Each face in the list of faces is represented by an index or pointer into the list of vertices for each vertex in the face. A triangular face is therefore represented by three vertex indexes or pointers. A sequence in which the vertex references are stored defines the orientation of the face—from a viewpoint “outside” a face, the face's sequence of vertices are counter-clockwise around the face. The edges of a face are not stored explicitly in the refined mesh data. Rather an edge is determined as a straight line connecting two adjacent vertices in the face by the module 196. Each face has a normal vector. A normal vector is a vector perpendicular to the corresponding face, pointing towards the “outside” of the face given that the face is represented by a sequence of vertices ordered counter-clockwise around the face. The normal vector is also typically not stored explicitly. Rather, the normal vector is typically determined from the stored refined mesh data by the module 196. When required, the normal vector of a triangular face is determined by summing the cross product of any two edges of the triangle. The normal vector is typically normalised to have a magnitude of 1.

In execution of step 220, a face to process is selected from the refined mesh data, for example a next face can be selected from the list of faces. The search volume construction step 222 is invoked to construct a search volume for the selected face. The method 300, which operates to execute the step 222, is now described with reference to the method 300 of FIG. 3.

Referring to FIG. 3, the search volume construction process 300 executes to construct a number of planes. The constructed planes together bound and define the search volume. The method 300 may be implemented by one or more submodules of the application 133, stored in the memory 106 controlled by execution of the processor 105. The method 300 executes on the processor 105 to construct a search volume associated with each polygon of the received polygon mesh.

The method 300 starts at step 310. Step 310 executes to determine a coincident back plane of the search volume for the selected face. A unique plane passes through the three vertices of any non-degenerate triangular face. Such a plane this is the coincident back plane of the selected face. The “in” side of the back plane is towards the interior of the refined surface mesh. The search volume accordingly relates to a volume inside a product represented by the refined mesh. The coincident back plane is preferably stored in memory (such as the memory 106). The coincident back plane is defined by three floating point numbers forming a 3D direction vector. The 3D direction vector forms the back plane's normal (perpendicular) direction, pointing towards the outside of the plane. The coincident back plane is also defined by a floating point distance value, being the distance along the direction vector from the origin of the co-ordinate system to the back plane.

The method 300 executes to continue from step 310 to step 320. In execution of step 320, a next edge of the selected face is selected. An edge is formed as a straight line segment between two consecutive vertices of a face. Concave faces share at least one vertex.

The method 300 executes to continue from step 320 to step 330.In execution of step 330, an initial bounding edge plane is determined. The initial bounding edge plane is perpendicular to the selected face (that is, the normal of the initial bounding edge plane is perpendicular to the normal of the selected face), and passes through the selected edge. Step 330 can, for example, be performed using three-point construction of a plane. Three-point construction of a plane involves choosing the two endpoints of the edge as two of the constructing points, and an edge endpoint plus the face normal vector as the third constructing point. Each bounding plane of the search volume divides 3D space into an inside part and an outside part, such that the inside part contains the selected face.

The method 300 executes to continue from step 330 to step 340. Step 340 executes to test concavity of the mesh surface at the selected edge. The selected edge is determined to be concave if, on the outside of the surface (the direction pointed by the normal vectors), an angle subtended by the surfaces of the two incident faces is less than 180°. The selected edge is concave if, on the respective faces adjacent to a concave edge, the face normals are converging rather than diverging. The concavity of the edge can for example be determined at step 340 by determining a dot product of the initial edge plane's direction vector with the normal vector of the neighbouring face to the selected face, and testing the sign of the result. If the sign of the result is negative, the edge is concave.

In determining that an edge is concave, step 340 effectively executes to determine a region between the search volumes of the selected face and an adjacent face which form the edge. If the edge is determined to be concave at step 340 (“Yes” at step 340), the method 300 executes to progress to step 350. Step 350 executes to “swing out” or expand the initial edge plane associated with the selected edge to expand the search volume. The “swinging out” or expansion is performed by adjusting the angle of the plane relative to the face in a direction which expands the search volume, while the plane remains passing through the selected edge. “Swinging out” the boundary effectively comprises re-orienting a boundary of the search volume, the boundary initially being substantially parallel with the polygon surface normal and passing through a shared vertex of the concave edges. Preferably, the plane's angle is set to be aligned with the normal of the selected edge, which is determined as the average direction of the normal of the selected face and the normal of the neighbouring face. In other arrangements, a weighted average direction may also be used.

The method 300 progresses to step 360 after expanding the edge plane outwards is completed in step 350. If the selected edge was determined to be not concave in step 340 (“No” at step 340), the method 300 continues from step 340 to step 360. Step 360 executes to test whether there are more edges in the selected face for which a bounding plane of the search volume has not yet been constructed. If step 360 returns a “Yes”, the method 300 executes to return to step 320. The steps 320 to 360 are repeated in which a next edge in the face is selected, and a further edge plane is constructed and “swung out” to expand the search volume, conditional on the relative directions of the face normal, and the normal of the neighbouring face across the edge. The method 300 continues to execute until a directional plane has been constructed for all edges, and the search volume for the face is fully defined by the intersection of the “in” sides of each directional bounding plane. A point is said to be “within” or “behind” a plane if the point lies on the “in” side of the plane. Once steps 320 to 360 have been completed for all edges of the selected face (“No” returned from step 360), the method 300 terminates.

In other arrangements of the method 300, other mathematical or geometrical operations may be performed to construct an identical search volume to that produced by the method 300. For example, the search volume may be determined by directly determining a number of planes, rather than constructing one or more planes and then modifying one or more of the constructed planes.

Referring to FIG. 2, the method 200 executes to continue from step 222 to step 225. The method 400, which, similarly to step 225, executes to find the nearest face within the search volume is now described with reference to FIG. 4.

The method 400 may be implemented by one or more submodules of the application 133, stored in the memory 106 controlled by execution of the processor 105. Referring to FIG. 4, the search method 400 begins at selection step 410. Step 410 executes to select the nearest face to the selected face (as selected at step 220 of FIG. 2). The nearest face is determined at step 410 by a spatial query method known in the art, such as grid-based querying. Grid-based querying is enabled by a preparation step in which the volume containing the mesh is divided in three dimensions into grid cells. The faces intersecting each grid cell are added to a list associated with that grid cell. In order to find the nearest face to some point in 3D space, the search can be first limited to the faces associated with the grid cell containing the point using a standard grid search technique. For example, the grid search may entail determining the distance from the point in 3D space to each face in the cell, sorting the results by distance, nearest first, and selecting the first result. Whenever a distance is obtained which is longer than the distance from the point in 3D space to some as yet unconsidered neighbouring grid cell, the faces in the neighbouring grid cell are similarly processed by determining the distance from the point in 3D space to each face, sorting the results by distance, and merging the list with the existing list.

The shape of the search volume can further be exploited to avoid expanding the search to grid cells which lie completely outside of the search volume, such as grid cells lying entirely behind the back plane of the search volume; searching such cells would never find a face within the search volume. In particular, grid cells intersecting the search volume can be selected at the beginning of the step 410, before identifying faces intersecting each grid cell. Thus, only selected grid cells are used to find candidate faces by identifying faces intersecting the selected grid cells. Then, the found candidate faces are used to search for the nearest face to the selected face.

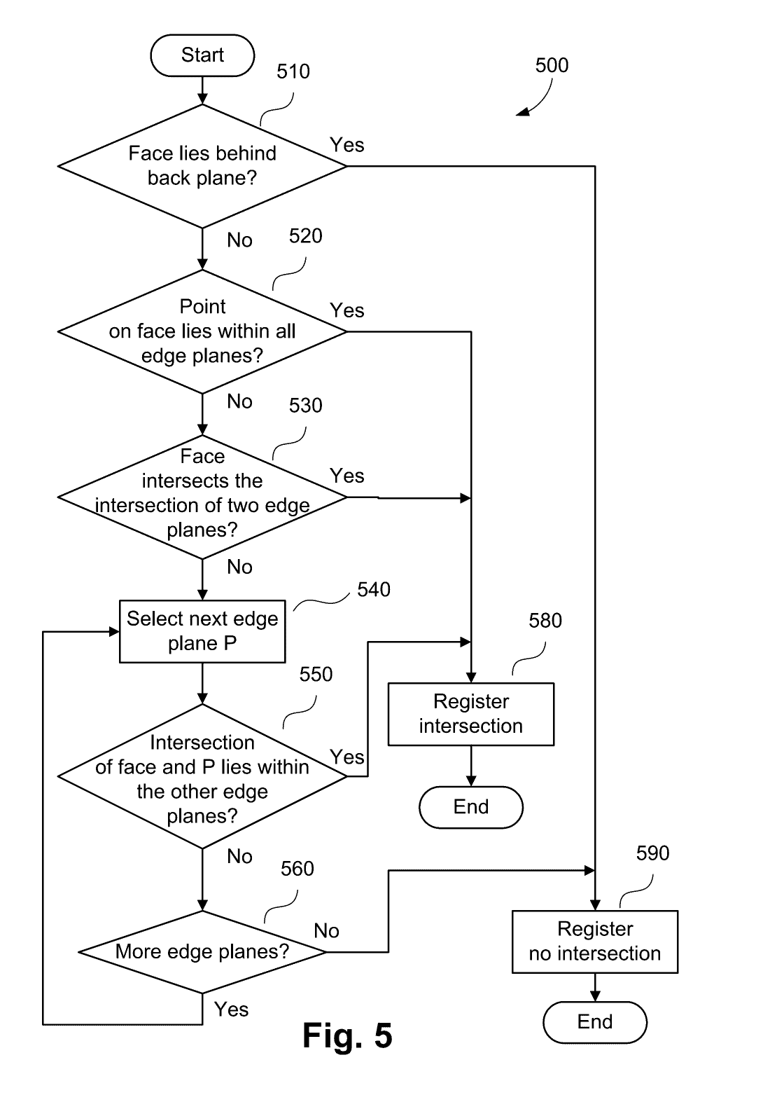

Execution of step 410 results in selection of a nearest face to the selected face. However at this stage of the method 400, it is not known whether the selected face lies within the search volume associated with the selected face. The method 400 executes to progress from step 410 to step 415. Step 415 is executed to determine whether the selected face lies within the expanded search volume. A method 500 of determining whether the selected face lies in the expanded search volume, as executed at step 415, is described hereafter in relation to FIG. 5.

The method 400 executes to progress from step 415 to decision step 420. Decision step 420 executes to checks whether the selected face intersects the expanded search volume, according to the result of step 415. If the selected face does not intersect the search volume (“No” at step 420), the method 400 returns to selection step 410, in which the next nearest face to the selected face is found via the spatial query method previously described. The next nearest face is similarly tested in execution of step 415 to determine in step 420 whether the next selected face intersects the expanded search volume. The steps 410 to 420 are repeated until a next nearest face is selected which does intersect the search volume.

If decision step 420 executes to determine that the selected face does intersect the search volume (“Yes” at step 420), the method 400 executes to progress from step 420 to step 430. Step 430 executes to return the selected face to the wall thickness analysis method 200. The search method 400 terminates upon completion of step 430.

Because the output of the mesh repair module 194 is a refined mesh surface which is a consistently oriented closed manifold, this method 400 will find any face which does intersect the search volume. In other arrangements, the method 400 can be adapted to operate on a mesh containing holes by inserting an additional step (not shown) between the “No” case of decision step 420 and the selection step 410. The additional step operates to return the initial selected face in the case that no face was found which intersects the search volume. The effect of such an arrangement of the method 400 is to eventually assign the face a thickness of zero in step 230 of the method 200. This case can arise in a mesh containing holes when one of the holes completely encompasses a search volume.

The method for testing intersection 500, as executed at step 415, will now be described with reference to FIG. 5. The method 500 may be implemented by one or more submodules of the application 133, stored in the memory 106 controlled by execution of the processor 105. The intersect test method 500 tests whether a face intersects a search volume. A face may intersect a search volume without intersecting any of the boundaries of the search volume, for example when the face is completely inside the search volume. The intersect test method 500 receives a selected face and a search volume, as selected at step 410 of FIG. 4.

The method 500 starts at step 510. Step 510 executes to test whether the selected face lies behind the back plane of the search volume. The face is behind the back plane if all vertices of the face are behind the back plane. The step 510 determines if the selected face is behind the back plane using a standard point-plane test. In the standard point-plane test, the dot product of the back plane's direction vector with a vector from the origin to each set of vertex co-ordinates is compared to the back plane's distance value. Such may be approximated by testing whether the barycentre of the face lies behind the back plane. However some faces may then be incorrectly classified, reducing the overall accuracy of the wall thickness analysis module 196. If the selected face is determined to lie behind the back plane (“Yes” at step 510), then the selected face does not intersect the search volume. In such an instance, the method 500 progresses from step 510 to step 590. Step 590 executes to record a result of no intersection, and the method 500 terminates.

If the selected face does not lie behind the back plane (“No” in step 510), the method 500 executes to progress from step 510 to step 520. Step 520 executes to test whether the barycentre of the selected face lies within each of the edge planes, by performing the point-plane test for the edge planes. If the barycentre of the selected face lies within each of the edge places, the selected face intersects the search volume. If the selected face intersects the search volume (“Yes” at step 520), the method 500 progresses to step 580. Step 580 executes to record a result of intersection, and the method 500 terminates.

If the barycentre of the selected face lies outside one or more of the edge planes (“No” in step 520), the face could still intersect the expanded search volume, but only if the face crosses a boundary plane of the search volume at some point. The method 500 executes to progress from step 520 to step 530. Step 530 executes to test each intersection of two neighbouring edge planes in the expanded search volume, for example using a known plane-plane intersection technique. The plane-plane intersection technique involves solving for a point that lies simultaneously on both planes, and forming a line using the solved point and a direction that is perpendicular to both plane normal directions. The plane-plane intersection technique requires that the planes be non-parallel. The planes are guaranteed to be non-parallel if the polygons in the mesh are non-degenerate. As previously described, the polygons in the mesh are non-degenerate as a result of execution of the mesh repair module 194. Step 530 executes to determine whether any of those lines of intersection intersect the face. In such an event, the face lies within the search volume (“Yes” at step 530), and the method 500 progresses to step 580. At step 580, a result of intersection is recorded, and the method 500 terminates.

If the face does not intersect an intersection of two planes (“No” at step 530), the method 500 progresses from step 530 to step 540. In such an instance, the face intersects the expanded search volume if and only if the face crosses one edge plane, and lies within each of the other edge planes. Step 540 executes to select the first (next) edge plane P.

The method 500 progresses from step 540 to step 550. Step 550 executes to find the intersection of the face with the edge plane P. If any point on the line of intersection (such as the midpoint of the line of intersection) lies within all of the other edge planes, using the standard point-plane test, the face intersects the search volume. In such an instance, the step 550 returns a “Yes” and the method 500 progresses to step 580. At step 580, a result of intersection is recorded, and the method 500 terminates.

If step 550 returns a “No”, the method 500 continues to step 560. Step 560 executes to determine if there are more edge planes to be tried. If there are more edge planes to be tried (“Yes” at step 560), the method 500 returns to step 540 in which the next edge plane is selected and similarly tested at step 550. The step 540 to 560 continue until either an edge plane is found whose intersection with the face lies between the other edge planes, or until all edge planes have been tried. If step 560 executes to determine there are no more edge planes to test (“No” at step 560), then step 560 determines that the face does not intersect the search volume. The method 500 progresses from step 560 to step 590. At step 590, a result of no intersection is recorded, and the method 500 terminates.

The result of determination of intersect test method 500 (either intersection or no intersection) is used by the search method 400 as previously described.

After the search method 400 completes, the wall thickness analysis method 200 executes to determine in step 230 the distance between the returned face from search method 400, and the selected face.

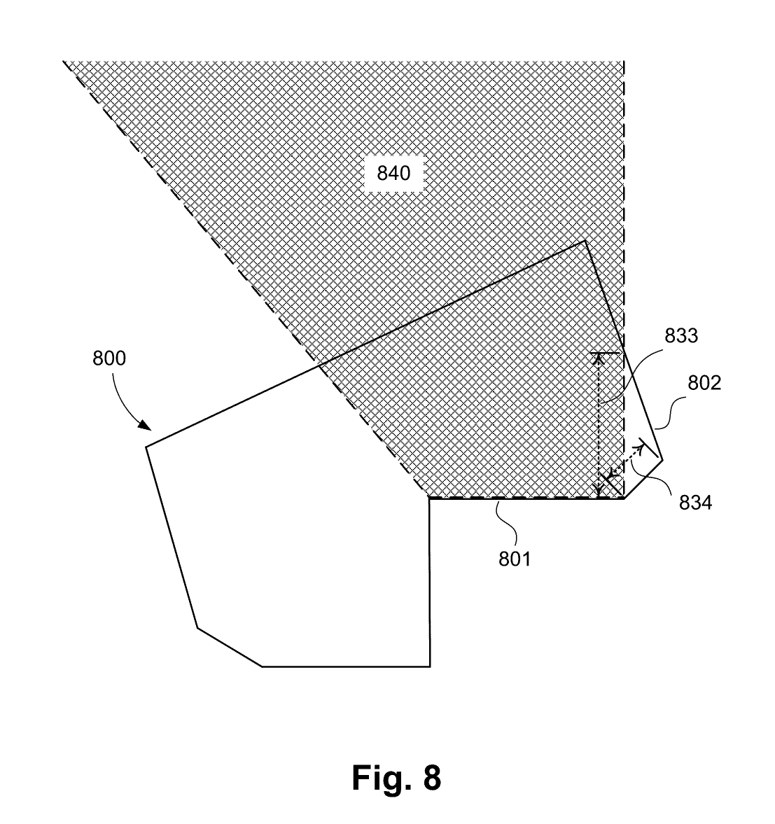

The distance determined in step 230 can be determined in more than one way, as described with relation to FIG. 8. FIG. 8 shows a shape 800. In shape 800, a face 802 has been identified as the nearest face to a face 801 within a search volume 840. Preferably, execution of step 230 determines a shortest distance 833 between the portion of the returned face 802 within the search volume 840, and the face 801. A shortest distance 834 between the returned face 802 and the face 801 is an alternative distance which is relatively simpler to determine, and is generally acceptable as an approximation. In each case, a triangle-triangle distance computation can be based on the shortest distance out of the set of six distances from each edge of each triangle to the other triangle. In a preferred arrangement, the returned face is first intersected with the search volume, and, if the intersection is not triangular, the intersection is broken into triangles. The wall thickness of the selected face is set to the calculated distance.

Referring back to FIG. 2, step 240 of wall thickness analysis method 200, determines whether the surface mesh contains any more faces whose wall thickness has not yet been set. If so (“Yes” at step 240), the method 200 returns to step 220 in which another face of the refined mesh model is selected, for which a search volume is constructed (step 222 or method 300), the nearest face in the search volume is found (step 225 or method 400), and the wall thickness of the face is set (step 230). Otherwise (“No” at step 240), the method 200 terminates.

The method 200 finds a wall thickness for each face of the mesh. As previously described, wall thickness measurements are important for identifying potential printability issues. For example, walls which are too thin may cause printing failures such as holes or disconnections. Whether a wall is too thin depends both on the capabilities of the 3D printer device 185, and the material being used to print. For example, if printing using a plastic material, walls whose thickness is 0.7 mm or smaller may be too thin to ensure successful printing. If printing using steel, walls whose thickness is 3mm or smaller may be too thin.

Furthermore, every pair of neighbouring faces which share a concave edge have expanded search volumes which abut with no gaps therebetween. The method 300 avoids each potential gap region by expanding a pair of search volumes on either side of the gap region for a face and a neighbour face sharing an edge, so that the region is covered by a combination of the search volumes of the face and its neighbour. For example, the combination of expanded search volumes from each face to the edge normal will cover the region or gap between the initial search volumes associated with each face. Expansion of the search volumes from each face to an edge normal represents a preferred arrangement. In other arrangements of the method 300, the search volumes of each face may be expanded according to other constraints to ensure that the region between the faces is covered by a pair of expanded search volumes. For example, a search volume may be expanded to fully cover the region between the initial search volumes in a single expanded search volume. Alternatively, the initial search volumes may be expanded so as to create overlapping expanded search volumes relating to each concave face.

Expansion of the search volumes to have no gaps ensures that any thin geometry, no matter the complexity or scale thereof, will be detected at faces on the corresponding surfaces, and the wall thickness information will be correctly determined and reported for the whole mesh relating to the object. The arrangements described can be performed in a fully automatic manner, since the arrangements do not rely on any manual parameters.

The search volumes of neighbouring faces across convex edges are not expanded, and typically overlap. This is appropriate for a simple model such as a cube. Search volumes of various polygon faces of the cube need to “look through” each other to find corresponding opposite faces to produce the correct wall thickness information.

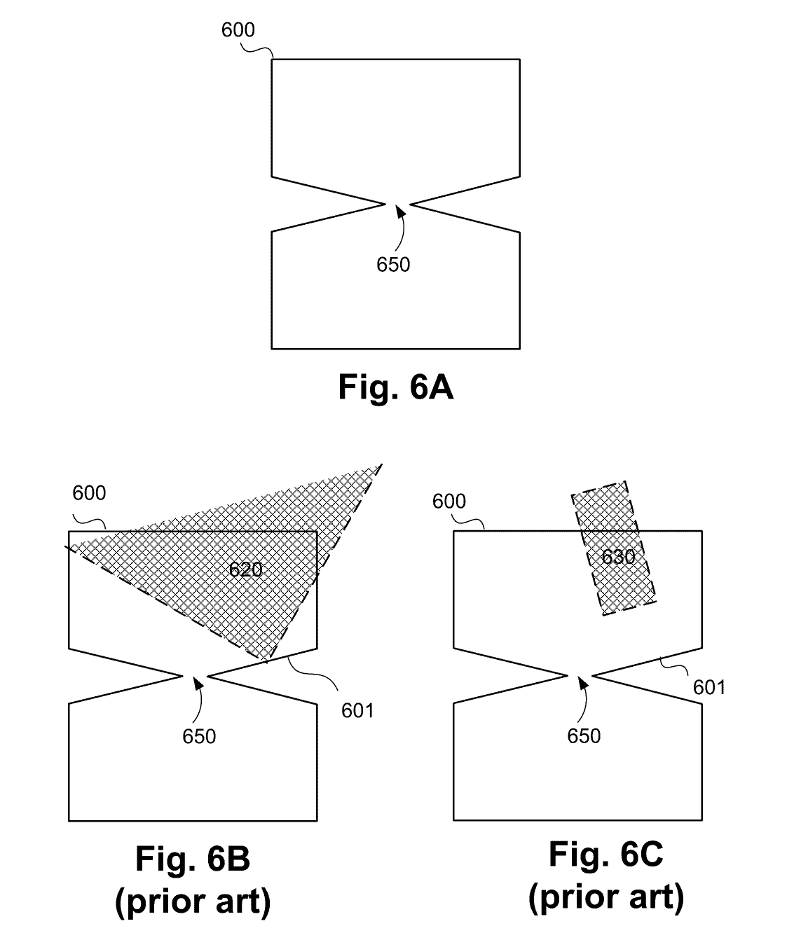

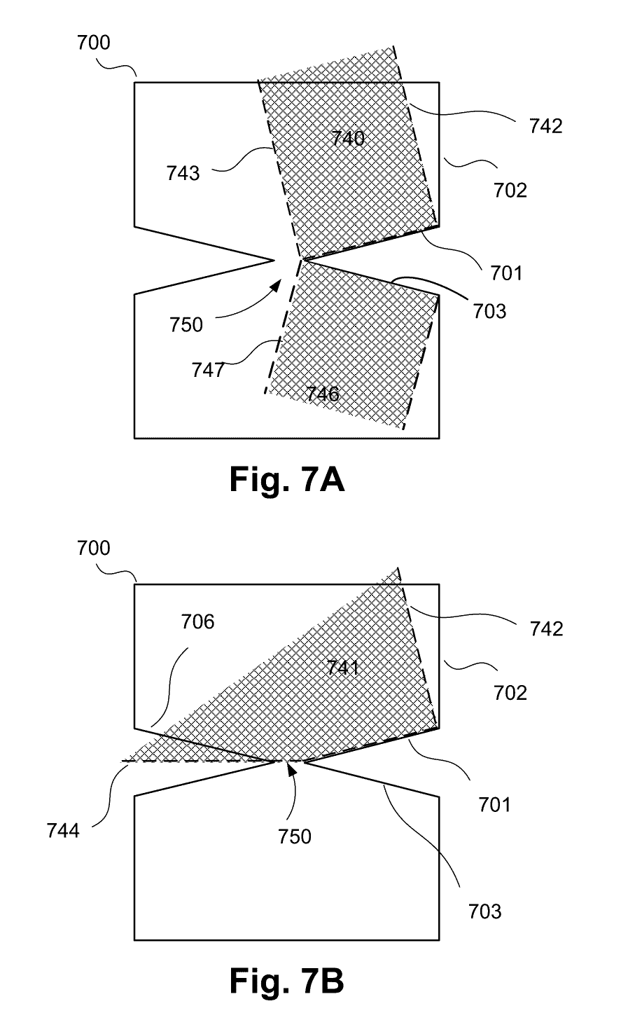

The shape 600 has the thin waist region 650 whose cross-section is depicted in FIG. 6A. FIG. 7A shows a similar shape 700 with a similar thin waist region 750. The wall thickness analysis method 200 detects the thin region 750 when executed for the shape 700, as described below. The shape 700 may for example be considered to be a rod with cross section as shown in FIG. 7A. Although the method 200 is fully applicable to three-dimensional shapes, a two-dimensional example is given herein for simplicity of description. After the shape 700 is received in step 210 of the method 200, step 220 selects face 701.

The method 200 executes to progress to step 222. The method 300 of FIG. 3 executes at step 222 to construct a search volume associated with the face 701.

Step 310 of FIG. 3 executes to construct a back plane of the search volume. The back plane is coincident with the selected face 701. Step 320 executes to iterate through the edges of the selected face 701 one by one.

For a first edge (not shown in the cross-sectional view of FIG. 7A), step 330 executes to determine an edge plane perpendicular to the face 701. Step 340 executes to determine that the neighbour across that edge is not concave, and step 360 executes to continue to the next edge.

In receiving a refined mesh model at step 210, and selecting a face at step 220, the application 133 effectively operates to receive a face or polygon of a single surface mesh model. In selecting a next edge (step 320, the application 133 effectively operates to receive a neighbouring polygon or face of the mesh. Iterative execution of step 330 for the shape 700 operates to associate search volumes with the initial and neighbouring polygons.

For a second edge, shared by faces 701 and 702, step 330 determines perpendicular edge plane 742, and step 340 tests whether the second edge is concave. The second edge is not concave, so step 360 continues to the next edge.

For a third edge, shared by faces 701 and 703, step 330 determines perpendicular edge plane 743. The edge 701 may be considered an initial face or polygon, and the face 703 a neighbouring edge in this example. The edges 701 and 703 form at least one vertex of the refined surface mesh associated with the third edge. An initial search volume 740 is shown extending perpendicularly away from a bounding back plane coincident with face 701, with two bounding edge planes 742 and 743. A third edge plane is not shown due to the two-dimensional nature of FIG. 7A. The search volume 740 is unbounded in extension away from face 701, indicated by the lack of a dashed boundary. The search volume 740 is effectively bounded by the face 701 and three boundary planes, including the planes 743 and 742, and another boundary plane (not shown due to the two-dimensional nature of FIG. 7A).

Step 340 tests whether the third edge is concave. Because the third edge, shared by faces 701 and 703, is a concave edge, then in step 350, edge plane 743 is “swung out” or expanded such that, as shown in FIG. 7B, a re-oriented edge plane 744 is still coincident with the edge between face 701 and face 703. However, orientation of the plane 744 is now aligned with the edge normal (substantially midway between the normal of face 701 and the normal of neighbouring face 703). The step 350 creates an expanded search volume 741, bounded by the perpendicular edge plane 742 and the adjusted edge plane 744 (expanded into the region beyond original bounding plane 743). The expanded search volume 741 is still unbounded in extending away from the face 701, indicated by lack of a dashed boundary.

In later iterations of the method 300, an initial search volume 746 associated with the face 703 is determined, in a similar manner to that for the face 701. The initial search volume 746 comprises a boundary 747. In determining whether the third edge is concave in step 340, the method 300 effectively executes to determine a region between the search volumes 740 and 746 associated with the faces 701 and 703 forming the third edge. Execution of step 350 effectively operates to expand the search volume associated with the initial selected face 701 toward the determined region between the search volumes 740 and 746 (between the boundaries 743 and 747) to form the expanded search volume 741. Step 350 operates to rotate the boundary plane 743 about the shared edge of face 701 and the neighbouring face 703.

If the search volume 746 were expanded (not shown) in a similar manner to the volume 740, the expanded search volume would abut the boundary 744, such that the region between the boundaries 743 and 747 would be fully covered by the expanded search volumes. The determined region is accordingly covered by a combination of the search volumes of the face (polygon) 701 and neighbouring face 703.

After the search volume 741 has been created by the search volume construction method 300, the wall thickness analysis method 200 continues by executing the step 225, that is the search method 400. The method 400 uses the face 701 for the selected face, and the search volume 741 for the search volume.

The search method 400 executes to find the nearest face to selected face 701 within the search volume 741 using a standard spatial query method in step 410. In the first two iterations of the process 400, the step 410 identifies faces 702 and 703 as being nearest to the face 701. The faces 702 and 703 are zero distance away from the face 701, since the faces 702 and 702 each touch the face 601 at an edge. When executed for the face 702 and the search volume 741, the intersect test method 500 determines that face 702 does not intersect search volume 741 as no valid intersection is found across any plane (“No” at step 560). When executed for the face 703 and the search volume 741, the intersect test method 500 determines that the face 703 does not intersect search volume 741 due to the face 703 lying behind the back plane of the search volume (“Yes” at step 510).

After faces 702 and 703 are rejected at step 420, a face 706 is selected at step 410. When executed for the face 706 and the search volume 741, the intersect test method 500 determines that the face 706 does intersect the search volume 741, due to a point on the face lying within all edge planes (“Yes” at step 520). Step 430 executes to return the selected face 706 to the wall thickness analysis method 200. Step 230 executes to determine the distance between face 706 and the search face 601, and stores the distance as the wall thickness of face 701 in the memory 106. The stored distance correctly represents the thickness of the waist 750.

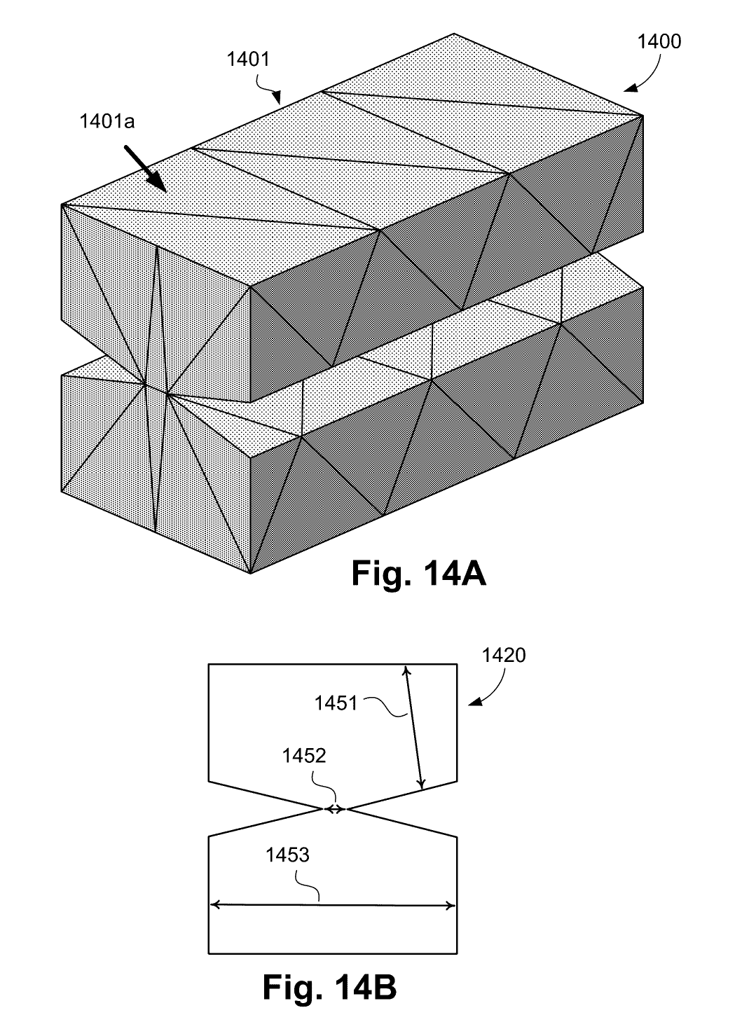

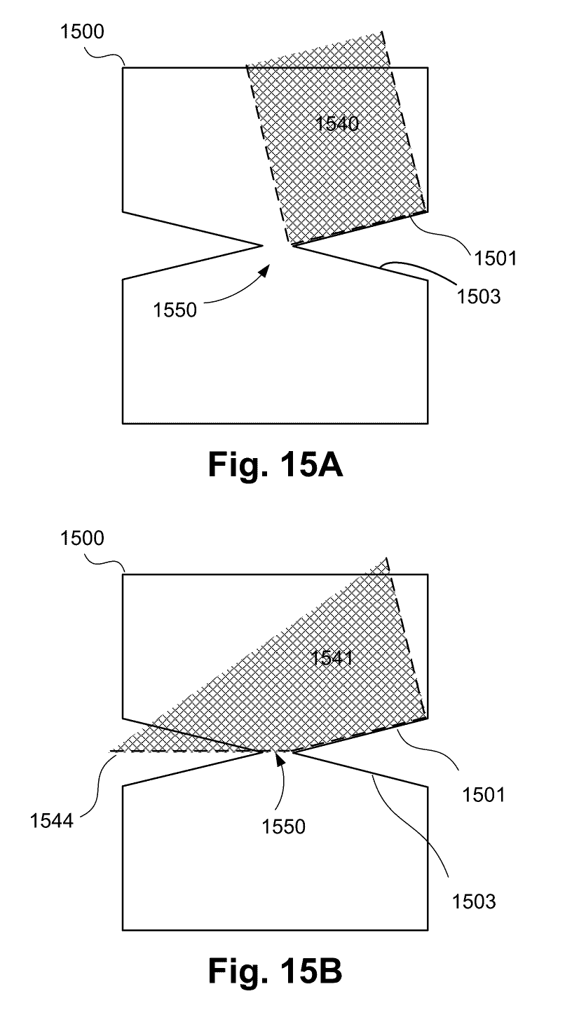

FIG. 15A shows a shape 1500 similar to the shape 700. The shape 1500 has a similar thin waist region 1550 similar to the region 750.

The method 200 is executed for the shape 1500 in a similar manner to the described in relation to FIGS. 7A and 7B. Operation of the method 200 and associated methods 300, 400 and 500 are as previously described unless indicated otherwise. In execution of steps 210 and 220, the application 133 effectively operates to select an initial polygon or face, a polygon 1501 as shown in FIG. 15A. The polygon 1501 is associated with an initial search volume 1540 by execution of step 330. The polygon 1501 shares a vertex with a neighbouring polygon 1503. In execution of step 340, the application 133 operates to determine whether the initial polygon 1501 forms a concave set with any neighbouring polygons. As the polygons 1501 and 1503 form a concave set (the polygons 1501 and 1503 form a concave edge), step 340 returns a “Yes” when edge 1503 is selected at step 320.

Corresponding execution of the step 350 expands the search volume 1540 associated with the selected polygon 1501 towards a region between a normal of the surface of the face 1501 and a normal of the surface of the face 1503. Such results in an expanded search volume 1541, as shown in FIG. 15B.

The method 300 continues to execute as described in relation to FIG. 3. Upon completion of the method 300, the method 200 progresses from step 222 to step 225. The method 200 executes steps 225 to 240 as described hereinbefore.

Similarly to the description in relation to FIGS. 7A and 7B, the region between the normal to the surface of the face 1501 and the normal to the surface of the face 1503 of FIGS. 15A and 15B is covered by a combination of search volumes relating to the initial face 1501 and the adjacent face 1503. The region is covered with no gaps, because bounding plane 1544 is shared by both expanded search volume 1541 associated with face 1501, and the expanded search volume associated with the neighbouring face 1503 which forms a concave set with face 1501.

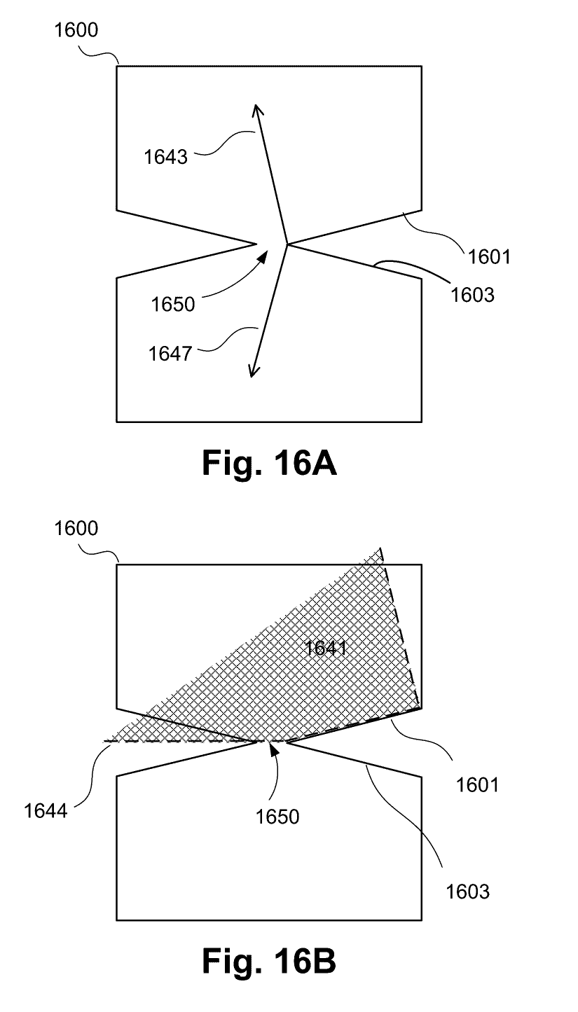

FIG. 16A shows a shape 1600 similar to the shape 700. The shape 1600 has a similar thin waist region 1650 similar to the region 750.

The method 200 is executed for the shape 1600 in a similar manner to the described in relation to FIGS. 7A and 7B. Operation of the method 200 and associated methods 300, 400 and 500 are as previously described in relation to FIGS. 3, 4 and 5 unless indicated otherwise.

In execution of step 210, the application 133 effectively operates to receive a pair of faces or polygons 1601 and 1603, as the polygons 1601 and 1603 form a part of the received refined mesh data. For example, the application 133 may execute to receive the mesh data in terms of edges, each edge defining a pair of incident faces, or may sort all faces of the refined mesh data received into adjacent pairs. However, instead of the full method 300, the application 133 executes the step 340 on its own to determine if any pair received in step 210 is a concave pair.

If the received pair of faces 1601 and 1603 is determined to be a concave pair, by returning “Yes” at step 340, the application 133 progresses to determine a search volume 1641 (FIG. 16B) extending inside the object for each polygon in the identified pair. One of the bounding planes 1644 of the determined search volume 1641 passes through a shared vertex of the pair of faces 1601 and 1603 in a direction defined by normal vectors 1643 and 1647 (FIG. 16A) of the pair of faces 1601 and 1603 respectively. Preferably, the direction of the plane 1644 is determined so that it substantially bisects normal vectors 1643 and 1647. In other arrangements, other weighted directions defined by the normal vectors 1643 and 1647 are also possible.

The arrangement described in relation to FIGS. 16A and 16B effectively operates to complete steps 330 and 350 of FIG. 3 as a single operation to create the volume 1641 as an expanded search volume. Once search volumes are created for all received face pairs, the method 200 progresses to step 225 and continues to execute as described in relation to FIG. 2. In execution of step 225, the method 200 effectively operates to determine a distance between face 1601 and a further face within the associated expanded search volume 1641.

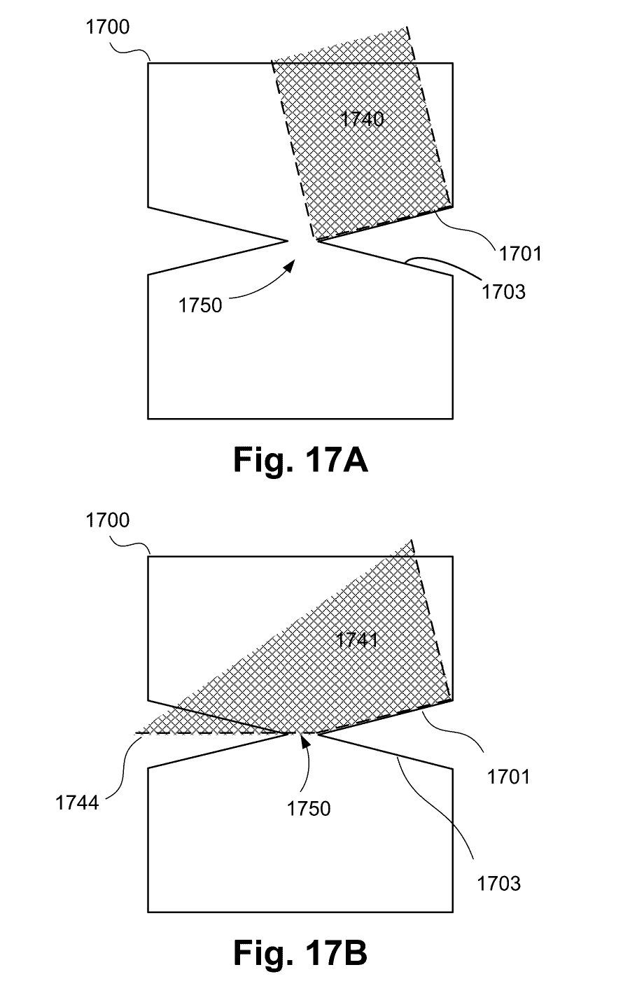

FIG. 17A shows a shape 1700 similar to the shape 700. The shape 1700 has a similar thin waist region 1750 similar to the region 750.

The method 200 is executed for the shape 1700 in a similar manner to the described in relation to FIGS. 7A and 7B. Operation of the method 200 and associated methods 300, 400 and 500 are executed as previously described in relation to FIGS. 3, 4 and 5 unless indicated otherwise.

In execution of steps 210, 220, and 340, the application 133 effectively operates to select a polygon (1701) from the received refined mesh model forming a concave angle with at least one neighbouring polygon (1703).

At step 350, the application 133 operates to dynamically vary a search volume 1740 associated with the polygon 1701. The search volume is dynamically varied according to determinable constraints associated with the selected polygon 1701 and a concave neighbouring polygon 1703. For example, the constraints may require the search volume to be varied based upon the orientation of the selected polygon relative to the neighbouring polygon 1703. The constraints require that any potential gaps associated with the search volume be covered by the varied search volume of the selected polygon, or a combination of the varied search volume and another search volume. The constraints may relate to expansion to a plane 1744 aligned with a normal between the selected and neighbouring faces, or expansion to meet or overlap another search volume, for example. In the example of FIGS. 17A and 17B, the constraints vary the search volume 1740 to a search volume 1741, shown in FIG. 17B

The application 133 execute step 350 to dynamically vary the search volume 1740 to determine a wall thickness of the selected polygon 1701, typically by execution of the step 360 onwards on the method 300 and progressing to complete steps 225 onwards of the method 200. The application 133 may progress upon finding that no more faces are available (“No” at step 220) to determine a printability of the refined mesh model. The printability may be determined in a number of ways, for example by comparison of the determined wall thickness to thresholds associated with one or more of capabilities of the 3D printing device 185, and properties of a material used by the 3D printing device 185.

The disclosed arrangements may also be applied to a quadrilateral mesh rather than a triangular mesh. The method 200 and the related methods 300, 400, and 500 are executed as previously described in relation to FIGS. 2-5, 7A and 7B for a quadrilateral mesh. Determining the normal to a (non-degenerate) triangular face is a relatively simple calculation with a unique answer, because all three vertices of the face must lie in a single plane. However, such may not apply for the vertices of a quadrilateral face.

In general, a quadrilateral face may not be perfectly flat. The normal of a quadrilateral face is calculated by summing the cross product of each pair of adjacent edges, of the quadrilateral face. The cross product is typically normalised to a vector of magnitude 1. The barycentre of a quadrilateral face is the average of the four vertex co-ordinates. For example, in step 310 of the search volume construction method 300 (FIG. 3), the back plane is constructed for a quadrilateral mesh such that the back plane normal matches the normal of the quadrilateral face. The back plane passes through the barycentre of the quadrilateral face.

By applying such calculations on quadrilateral mesh faces rather than triangular mesh faces, the subsequent steps of the method 200 can be executed to determine the wall thickness of an object represented by the quadrilateral mesh. Similar adaptations are possible to apply the arrangements described to polygon meshes of other face configurations, including meshes with mixed face types.

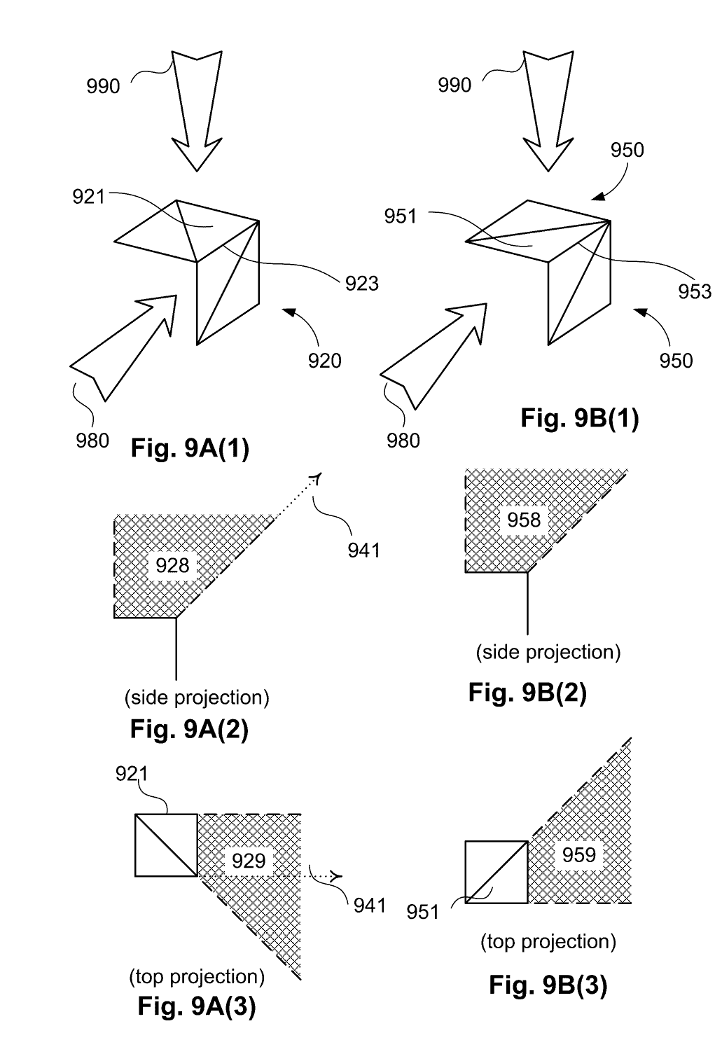

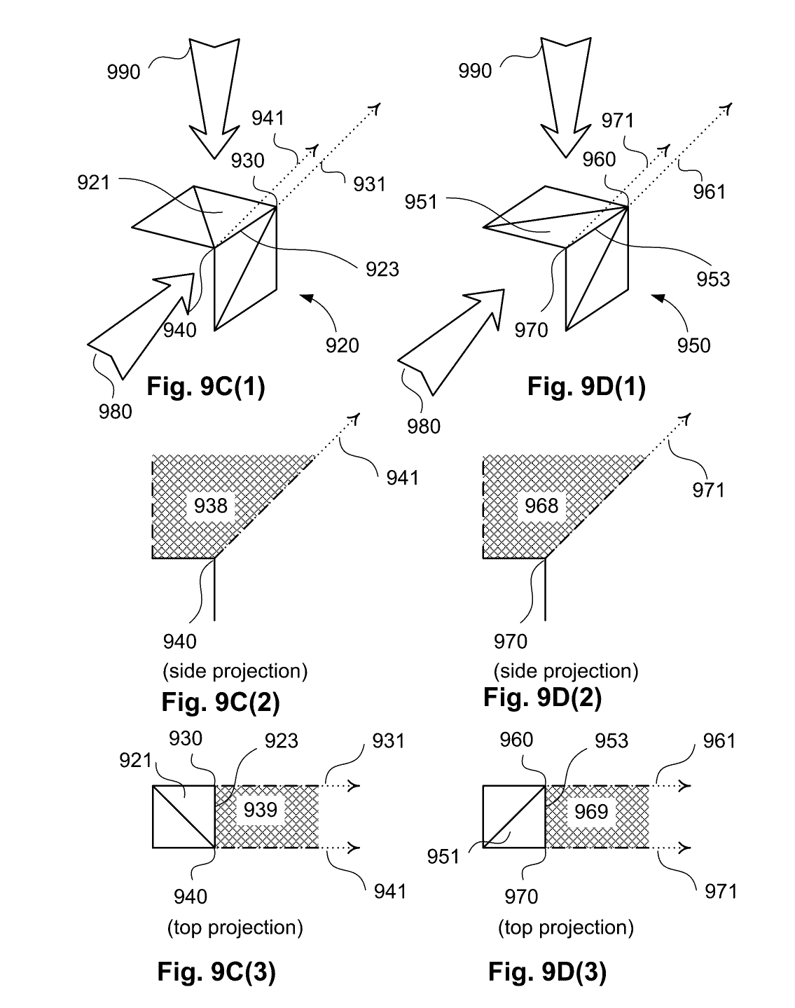

In another arrangement, additional constraining planes are added to the search volume to minimise undesirable effects caused by the shape of local faces. Such undesirable effects include expansion in a direction not related to the edge about which the search volume is expanded, leading to unnecessarily large search volumes and complexity of calculation. Such is described with reference to the example of FIGS. 9A to 9D.

FIG. 9A(1) shows a concave edge 923 of a mesh surface 920. The concave edge 923 causes an expanded search volume for a face 921 as a result of execution of the search volume construction method 300. The expanded search volume is shown firstly as a projection 928 from a side perspective 980 in FIG. 9A(2). The expanded search volume is also shown as a projection 929 from a top perspective 990 in FIG. 9A(3).

FIG. 9B(1) shows a concave edge 953 of a mesh surface 950. Similarly to FIG. 9A(1), the expanded search volume caused by the concave edge is shown both from a side perspective 980 and a top perspective 990. The concave edge 953 causes an expanded search volume for face 951 in execution of the search volume construction process 300, shown as a projection 958 from the side perspective 980 in FIG. 9B(2), and a projection 959 from the top perspective 990 in FIG. 9B(3).

The edges 923 and 953 are functionally equivalent in the geometrically identical surfaces 920 and 950. However, the expanded search volumes 929 and 959 respectively subtended by the faces 921 and 951 adjacent the edges 923 and 953 are quite different when viewed from the top perspective 990. In each instance, the expanded search volumes 929 and 959 expand desirably upwards, as seen from the side perspective 980, in order to fill the gap between initial search volumes of face 921 or 951 on the top of the shape, and the corresponding adjacent face across corresponding edge 923 or 953. However, the search volumes 929 and 959 also expand unnecessarily to one side or an opposite side as seen from the top perspective 990. Such is a consequence of the geometry of the expanded search volume.

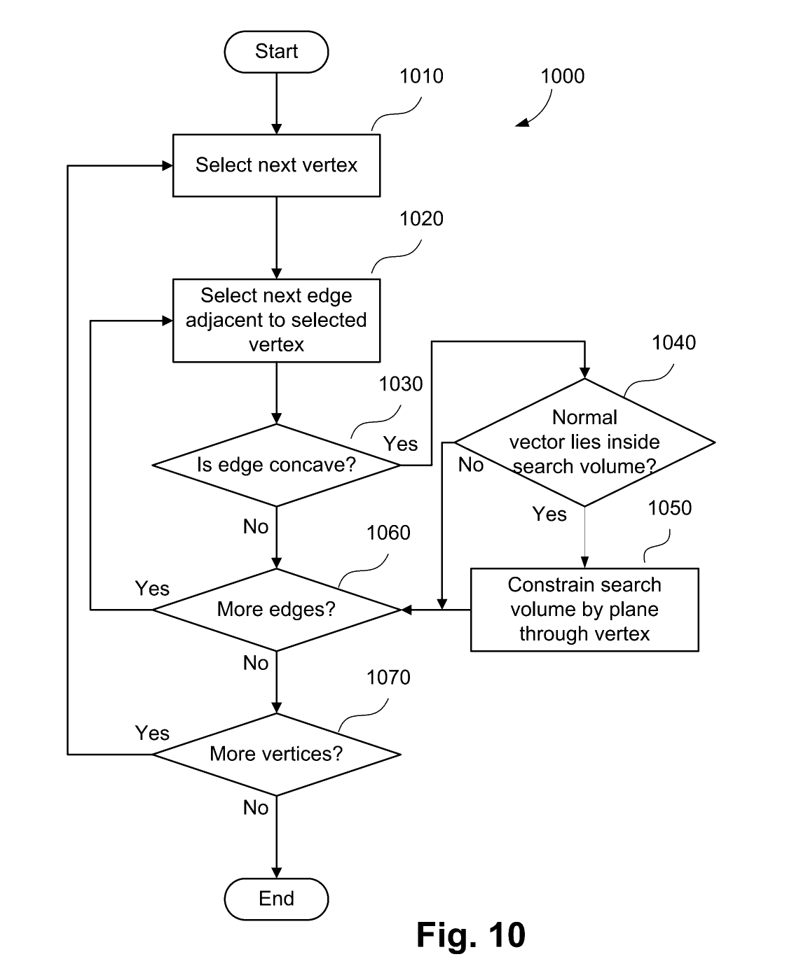

The dependency of the expanded search volume on the shape of local faces (polygons) can be avoided by a search volume constraining method 1000, now described in relation to FIG. 10. The method 1000 is executed by the wall thickness analysis method 200 after execution of the search volume construction method 300 at step 222. The method 1000 may be implemented by one or more submodules of the application 133, stored in the memory 106 controlled by execution of the processor 105. The method 1000 is typically executed as a sub-application of the module 196 on the processor 105.

With reference to FIG. 10, the search volume constraining method 1000 begins by selecting a vertex of the selected face at step 1010. The method 1000 executes to progress to step 1020. Step 1020 executes to select an edge of the selected face that is adjacent to the vertex selected in step 1010. The method 1000 executes to progress to step 1030. Step 1030 executes to determine whether the selected edge is a concave edge. If so, the selected edge is a concave edge (“Yes” at step 1030), the method 1000 progresses to step 1040.

In execution of step 1040, the process 1000 executes to determine whether a normal direction of the selected vertex, when subtended from the selected vertex, lies strictly inside the expanded search volume. Such is determined using the previously described point-plane test for a point lying a distance along the vertex normal from the selected vertex. A normal which is tangential to a bounding plane of the expanded search volume is not considered strictly inside the expanded search volume. The normal of a vertex in a polygon mesh is determined using a weighted average of the normals to the surfaces of the surrounding faces. The normal of a vertex in a polygon mesh is typically normalised to magnitude 1, the surrounding faces of the selected vertex being the selected face and neighbouring faces which share the selected vertex.

If the vertex normal lies inside the search volume (“Yes” at step 1040), the method 1000 progresses to step 1050. In execution of step 1050, the search volume associated with the face is constrained by the addition of a further plane. The further plane is substantially perpendicular to the selected face, and passes through the normal of the selected vertex. The further plane can be determined using a three-point construction as previously described.

After the further plane has been added to the search volume in step 1050, the method 1000 progresses to step 1060. If the normal does not lie within the expanded search volume of the selected face (“No” at step 1040), the method 1000 progresses from step 1040 to step 1060. If, at step 1030, the selected edge is not concave (“No” at step 1030), the method 1000 progresses from step 1030 to step 1060.

Step 1060 executes to determine whether there are any more edges of the selected face which are adjacent to the selected vertex (there are a total of two edges adjacent to the selected vertex). If step 1060 determines that there is another edge (“Yes” at step 1060), the method 1000 returns to step 1020. Steps 1020 to 1060 are repeated such that a further constraining plane is potentially added, depending on the concavity of the edge. If the face has no more edges adjacent to the selected vertex (“No” at step 1060), the method 1000 progresses from step 1060 to step 1070. Step 1070 executes to determine whether the face contains any more vertices. If further vertices are determined (“Yes” at step 1070), the method 1000 returns to step 1010, and the next vertex is processed according to the steps 1010 to 1060. If all vertices of the face have been processed (“No” at step 1070), the method 1000 terminates.

An example of the effect of search volume constraining process 1000 is provided for local mesh surface 920 in FIG. 9C(1), with respect to edge 923. The method 1000 begins at step 1010 by selecting a vertex 930. Step 1020 executes to select the adjacent edge 923. Step 1040 executes to determine that a normal 931 of the vertex 930 does not lie strictly inside the expanded search volume. The method 1000 continues accordingly. After further iterations of the method 1000, step 1010 executes to selects a vertex 940, and step 1020 selects the adjacent edge 923. In this instance, the edge 923 is concave. Step 1040 determines that the normal 941 of vertex 940 does lie within the expanded search volume. Such is demonstrated by the top projection of shape 920 in FIG. 9A(1). In step 1050, the expanded search volume is constrained by the addition of a plane which is perpendicular to the face 921, and which passes through the normal 941 of the vertex 940. A side projection 938 of the constrained search volume, shown in FIG. 9C(2), is the same as the side projection of the search volume 928 of FIG. 9A(2) without the constraining plane. However, a top projection 939 of the constrained search volume shown in FIG. 9C(3) is rectangular, in contrast to the search volume 929 without the constraining plane of FIG. 9A(3).

Similarly, for the local mesh surface 950, execution of the method 1000 constrains the search volume by a plane which is perpendicular to the face 951, and which passes through a normal 961 of a vertex 960, as shown in FIG. 9D(1). A normal 971 of the vertex 970 does not constrain the expanded search volume as the normal 971 does not lie strictly inside the expanded search volume, as shown in FIG. 9D(2). The result of execution of the method 1000 is that the side projections 938 and 968 of the search volumes associated with corresponding faces 921 and 951 are formed to have the same shape, as shown in FIGS. 9C(3) and 9D(3). However, due to operation of the method 1000, the corresponding top projections 939 and 969 also have the same shape, in contrast to FIGS. A(3) and 9B(3). Operation of the method 1000 results in less variance (“noise”) in the wall thickness information based on local triangle shape.

The dependency on the shape of the local faces can also ameliorated by smoothing each wall thickness value with respect to neighbouring values as a final step of the wall thickness analysis method 200. However, a side effect such a smoothing filter is to reduce the accuracy of resulting individual wall thickness measurements.

In another arrangement, a search volume construction process 1100 for creating an evolved prism search volume for a face is invoked by the wall thickness analysis method 200 at step 222 instead of the search volume construction method 300.

The method 1100 may be implemented by one or more submodules of the application 133, stored in the memory 106 controlled by execution of the processor 105. The method 1100 may typically be implemented as one or more submodules of the module 196. The method 1100 begins at step 1110. Step 1110 executes to determine the coincident back plane, in the same manner as step 310 of the method 300.

The method 1100 executes to progress from step 1110 to step 1120. In execution of step 1120, an evolved prism search volume is determined. For a triangular face, the corresponding evolved prism search volume is a 3D shape whose cross section at any slice parallel to the face is also a triangle, possibly of a different shape or size to the triangular face. The cross section of an evolved prism is typically non-uniform. In a co-ordinate system whose z-axis points into the search volume of the triangular face, perpendicular to the face, and whose origin is at the barycentre of the face, the x and y co-ordinates of each corner of a triangular slice of an evolved prism search volume at a height of z are linear functions of z:

x₁(z)=A_{x1·}z+Bₓ₁; y₁(z)=A_{y1·}z+B_{y1}

x₂(z)=A_{x2·}Z+Bₓ₂; y₂(z)=A_{y2·}z+B_{y2}

x₃(z)=A_{x3·}z+Bₓ₃; y₃(z)=A_{y3·}z+B_{y3}

The vertices of the cross-sections of the evolved prism at a height above and perpendicular to the face are linearly dependent on the height. Each pair of equations defines one bounding edge of the search volume for the face, each bounding edge being associated with a vertex of the face. The Aₓᵢ, A_{yi}, Bₓᵢ, and B_{yi} parameters define how the evolved prism evolves for a particular edge i, 1≦i≦3 as z increases. At z=0, the equations find the vertex co-ordinates of the face, in the face co-ordinate system. Step 1120 executes to determine values of the parameters Aₓᵢ, A_{yi}, Bₓᵢ, and B_{yi} uniquely such that the co-ordinates (xₙ(z), yₙ(z), z) lie on a ray emanating from vertex n of the face and following the vertex normal. Thus, the evolved prism search volume for the selected face is bounded by rays which trace the normals of each vertex of the face. In the general case, apart from a base polygon surface at z=0, an evolved prism has non-planar surfaces.

As previously described, the normal of a vertex in a polygon mesh is calculated by a weighted average of the normals to the surfaces of the surrounding faces. The normal of the vertex is typically normalised to magnitude 1, the surrounding faces of the selected vertex being the selected face and neighbouring faces, which share the selected vertex.

The method 1100 progresses from step 1120 to step 1130. In execution of step 1130, a vertex of the face is selected. The method 1100 executes to progress from 1130 to 1140. Step 1140 executes to determine whether an initial portion, with length tending towards zero, of a ray cast from the vertex position in the direction of the face normal lies within the evolved prism. Whether a later portion of the ray lies within the evolved prism is not the subject of the test at step 1140. If not (“No” at step 1140), the method 1100 progresses from step 1140 to step 1150. Execution of step 1150 expands the search volume by redefining the bounding edge associated with the selected vertex i such that the bounding edge is aligned with the face normal:

Aₓᵢ=0; A_{yi}=0

After expanding the search volume at step 1150, the method 1100 progresses to step 1160. If at step 1140, the initial portion of a ray cast from the selected vertex along the face normal is determined to already lie within the search volume (“Yes” at step 1140), the method 1100 executes to progress from step 1140 to step 1160.

Step 1160 executes to determine whether the face has any more vertices which have not been analysed according to the method 1100. If the face has more vertices which have not been analysed, the method 1100 returns to step 1130. The steps 1130 to 1160 are repeated such that the next vertex is selected, tested (step 1140), and the search volume is again conditionally expanded (step 1150). The method 1100 terminates when all vertices have been processed (“No” returned at step 1160).

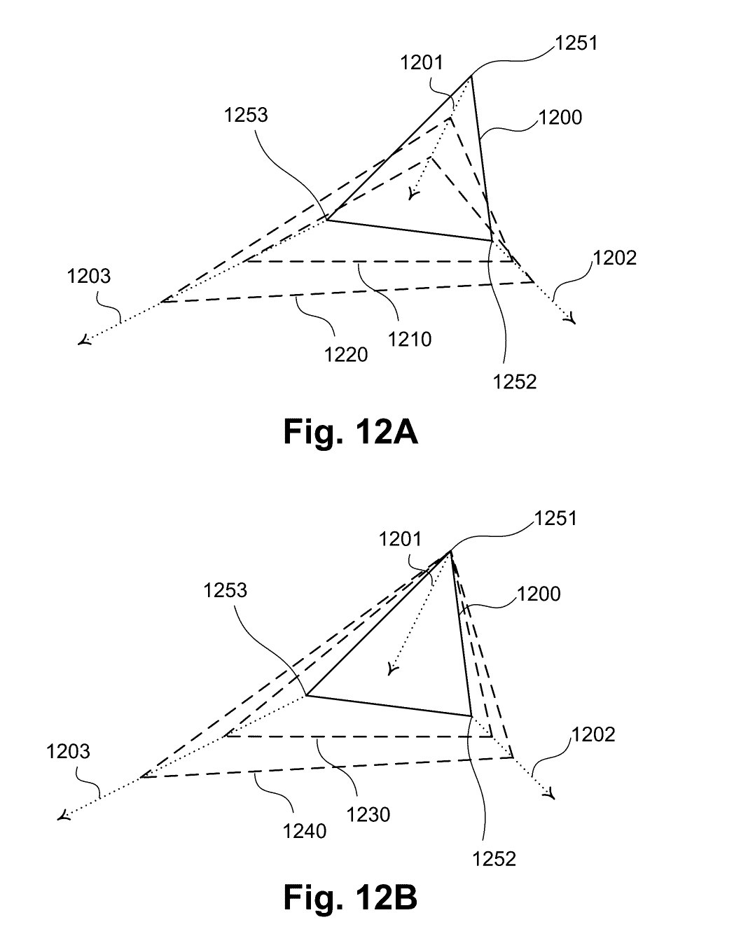

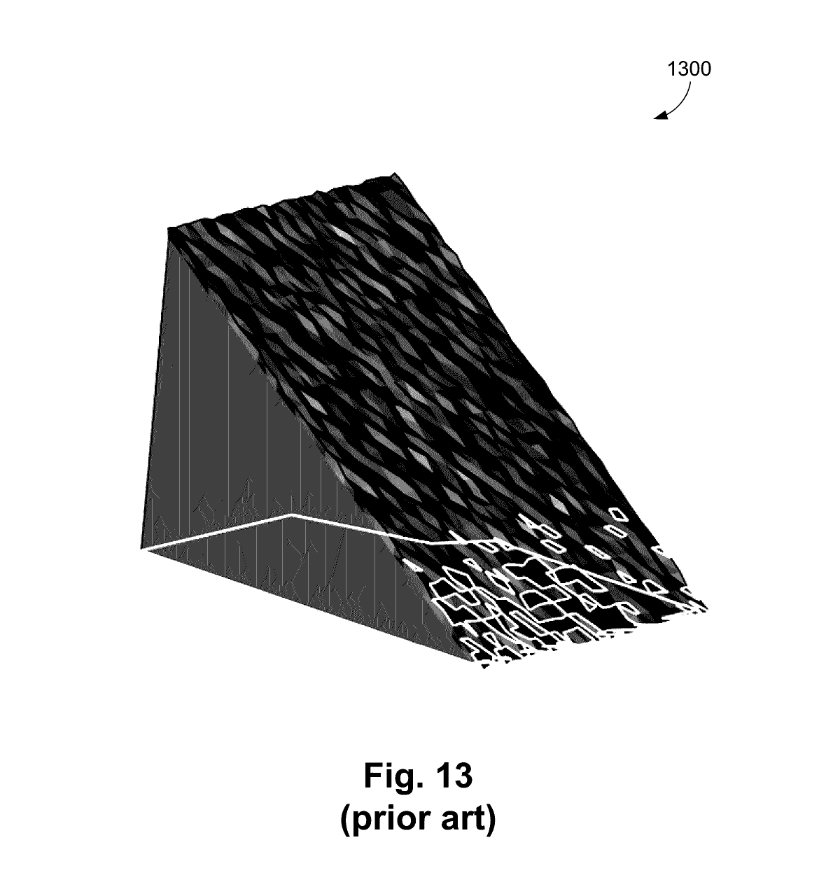

FIG. 12A shows a face 1200 and triangular cross sections 1210 at z=1, and 1220 at z=2. The cross-sections 1210 and 1220 are of an evolved prism search volume determined at step 1120 of the method 1100 for the face 1200. The search volume for FIG. 12A is defined by parameters:

Aₓ₁=−1; Bₓ₁=−5; A_{y1}=−2; B_{y1}=−2

Aₓ₂=1; Bₓ₂=3; A_{y2}=1; B_{y2}=−3

Aₓ₃=−4; Bₓ₃=2; A_{y3}=2; B_{y3}=5

The search volume is shown to have edge boundaries comprising vertex normals 1201, 1202, and 1203.

For the example of FIG. 12A, at execution of step 1130, a first vertex 1251 is selected. At execution of step 1140, the method 1100 determines that the initial portion, and indeed all of the face normal (coming directly “out of the page” at vertex 1251) lies outside of the evolved prism search volume. Accordingly, at execution of step 1150, the search volume is expanded by adjusting the prism boundary associated with the vertex 1251 to align with the face normal. As a result, the boundary of the search volume associated with vertex 1251 is no longer aligned with vertex normal 1201, as shown in FIG. 12B. At step 1150 of the method 1100, the search volume has triangular cross-sections 1230 at z=1, and 1240 at z=2, and is defined by the parameters:

Aₓ₁=0; Bₓ₁=−5; A_{y1}=0; B_{y1}=−2

Aₓ₂=1; Bₓ₂=3; A_{y2}=1; B_{y2}=−3

Aₓ₃=−4; Bₓ₃=2; A_{y3}=2; B_{y3}=5

The method 1100 finds more vertices at step 1160, and returns to step 1130 to select a second vertex 1252 (FIG. 12A). The start of a ray cast from vertex 1252 in the direction of the face normal lies inside the search volume. Accordingly, the method 1100 proceeds from step 1140 to step 1160, which finds still more vertices. Execution of step 1130 selects a third vertex 1253, and selection step 1140 again finds a face normal ray at the vertex 1253 whose beginning lies within the search volume. The method 1100 progresses to step 1160 to determine that there are no more vertices in the face to process, and the method 1100 terminates.

In addition to replacing search volume construction method 300 with search volume construction method 1100, intersect test process 500 may be replaced with a method for testing the intersection of a polygonal face with an evolved prism. The use of evolved prism search volumes constrained by vertex normals means that neighbouring polygon faces which share a concave vertex have search volumes which abut with no overlaps or gaps. Such further reduces the amount of unnecessary overlap between search volumes, reducing noise in wall thickness information.

The arrangements described are applicable to the computer and data processing industries and particularly for the 3D printing industries.

Printability of a single surface mesh model relates to (i) capabilities of the relevant printing device, and properties of a material from which the object is to be formed, and (ii) whether the printed object would be sufficiently robust for general use. The arrangements described herein provide for technical improvements in reliability of 3D printers, and accordingly, printability. The improvement lies in determining potential wall thickness problems prior to printing of the single surface mesh model. The improvement allows savings in terms of time, materials and other resources associated with printing single surface mesh models which have 3D printability problems.

The foregoing describes only some embodiments of the present invention, and modifications and/or changes can be made thereto without departing from the scope and spirit of the invention, the embodiments being illustrative and not restrictive.

1. A method of determining a wall thickness of an object defined by a surface mesh model, the method comprising:
receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon;
determining, based on normals to the surfaces of the initial polygon and the neighbouring polygon, a region inside the object, the determined region being between the search volumes of the initial polygon and the neighbouring polygon;
expanding the search volume associated with the initial polygon towards the determined region to form an expanded search volume, so that the determined region is covered by a combination of the search volumes of the initial polygon and the neighbouring polygon; and
determining the wall thickness of the initial polygon using a distance from the initial polygon to a further polygon within the expanded search volume.

2. The method according to claim 1, wherein the combination of the search volumes comprises a single expanded search volume.

3. The method according to claim 1, wherein the combination of the search volumes comprises a pair of expanded search volumes.

4. The method according to claim 1, wherein expanding the search volume associated with the initial polygon comprises re-orienting a boundary of the search volume, the boundary being substantially parallel with the initial polygon surface normal and passing through the at least one shared vertex.

5. The method according to claim 4, wherein re-orienting the boundary of the search volume comprises orienting the boundary at an angle substantially midway between the initial polygon surface normal and the neighbouring polygon surface normal.

6. The method according to claim 1, wherein the search volume associated with the initial polygon is substantially bounded by the initial polygon and three boundary planes, each boundary plane passing through an edge of the initial polygon.

7. The method according to claim 1, wherein the neighbouring polygon shares an edge with the initial polygon.

8. The method according to claim 1, wherein expanding the search volume comprises rotating the boundary plane passing through the shared edge about the shared edge.

9. The method according to claim 1, wherein the polygon is triangular.

10. The method according to claim 1, wherein the polygon is quadrilateral.

11. The method according to claim 1, wherein the expanded search volume is further formed by addition of one or more further bounding planes, the further bounding planes being substantially perpendicular to the initial polygon, and passing through one of the at least one vertices, substantially perpendicular to the vertex normal.

12. The method according to claim 1, further comprising expanding the search volume of the neighbouring polygon to cover the determined region.

13. The method according to claim 12, wherein the expanded search volumes of the initial polygon and the neighbouring polygon abut with no gaps therebetween.

14. The method according to claim 12, wherein the expanded search volumes of the initial polygon and the neighbouring polygon overlap.

15. A method for determining a wall thickness of an object defined by a surface mesh model, the method comprising:
selecting an initial polygon in the surface mesh model, the initial polygon being associated with a search volume extending inside the object substantially perpendicular to the surface of the initial polygon;
determining whether the initial polygon forms a concave set with an adjacent polygon from the surface mesh model, wherein the adjacent polygon shares at least one vertex with the selected polygon;
if the initial polygon and the adjacent polygon form a concave set, expanding the search volume associated with the selected polygon towards a region between the normal to the surface of the initial polygon and the normal to the surface of the adjacent polygon to form an expanded volume, so that said region is covered by a combination of search volumes of the initial polygon and the adjacent polygon; and
determining a distance between the initial polygon and at least one further polygon within the expanded search volume to determine a wall thickness of the object.

16. A method for determining a wall thickness of an object defined by a surface mesh model, the method comprising:
receiving a pair of concave neighbouring polygons sharing at least one vertex in the surface mesh model;
for each polygon in the pair, determining a search volume extending inside the object from the surface of the corresponding polygon and having at least one boundary passing through the shared vertex in a direction defined by normal vectors to the surfaces of the first and second polygons in the pair; and
determining the wall thickness of the object using a distance between a polygon in the pair and a further polygon within the respective search volume.

17. A method for determining printability of a surface mesh model, the method comprising:
selecting a polygon from the surface mesh model forming a concave angle with respect to at least one neighbouring polygon;
dynamically varying a search volume within determinable constraints associated with the selected polygon based on the orientation of the selected polygon relative to the at least one neighbouring polygon to determine the wall thickness of the selected polygon; and
determining printability of the surface mesh model using the determined wall thickness.

18. The method according to claim 17, further comprising determining the search volume associated with the selected polygon, the determined search volume being an evolved prism.

19. The method according to claim 18, wherein vertices bounding a cross-section of the determined search volume at a height above and perpendicular to the polygon is linearly dependent on the height.

20. The method according to claim 18, wherein the search volume is varied by redefining a bounding edge of the determined search volume associated with a selected vertex of the selected polygon such that the bounding edge is aligned with a normal of the selected polygon.

21. An apparatus for determining a wall thickness of an object defined by a surface mesh model, the apparatus comprising:
a memory; and
a processor coupled to the memory for executing a computer program, the computer program comprising instructions for:
receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon;
determining, based on normals to the surfaces of the initial polygon and the neighbouring polygon, a region inside the object, the determined region being between the search volumes of the initial polygon and the neighbouring polygon;
expanding the search volume associated with the initial polygon towards the determined region to form an expanded search volume, so that the determined region is covered by a combination of the search volumes of the initial polygon and the neighbouring polygon; and
determining the wall thickness of the initial polygon using a distance from the initial polygon to a further polygon within the expanded search volume.

22. A non-transitory computer readable storage medium having a program recorded thereon, the program being executable by a processor for determining a wall thickness of an object defined by a surface mesh model, the program comprising:
code for receiving an initial polygon of the surface mesh model and a neighbouring polygon of the surface mesh model, the neighbouring polygon sharing, in the surface mesh model, at least one vertex with the initial polygon, each received polygon being associated with a search volume extending inside the object substantially perpendicular to a surface of the corresponding polygon;
code for determining, based on normals to the surfaces of the initial polygon and the neighbouring polygon, a region inside the object, the determined region being between the search volumes of the initial polygon and the neighbouring polygon;
code for expanding the search volume associated with the initial polygon towards the determined region to form an expanded search volume, so that the determined region is covered by a combination of the search volumes of the initial polygon and the neighbouring polygon; and
code for determining the wall thickness of the initial polygon using a distance from the initial polygon to a further polygon within the expanded search volume.

23. A system, comprising:
a 3D printing device;
a computing device; and
a communications network coupling the computing device to the 3D printing device; wherein
the system is adapted to
receive, at the computing device, an initial polygon of a surface mesh model and a neighbouring polygon of the surface mesh model, the surface mesh model representing a product for printing by the 3D printing device, the neighbouring polygon sharing, in the surface mesh model, at least one vertex with the initial polygon, each received polygon being associated with a search volume extending inside the object substantially perpendicular to a surface of the corresponding polygon;
determining, by the computing device, based on normals to the surfaces of the initial polygon and the neighbouring polygon, a region inside the object, the determined region being between the search volumes of the initial polygon and the neighbouring polygon;
expand, by the computing device, the search volume associated with the initial polygon towards the determined region to form an expanded search volume, so that the determined region is covered by a combination of the search volumes of the initial polygon and the neighbouring polygon; and
determine, by the computing device, the wall thickness of the initial polygon using a distance from the initial polygon to a further polygon within the expanded search volume; and
print, by the 3D printing device, the product represented by the surface mesh model depending on the determined wall thickness.
